(19) United States
(12) Patent Application Publication
(10) Pub. No.: US 2026/0249299 A1
(43) Pub. Date: Aug. 27, 2026

(54) MASTERMIX INTEGRATION INTO CARTRIDGE-BASED IN VITRO DIAGNOSTICS DEVICE

(71) Applicant: Inflammatix, Inc., Sunnyvale, CA (US)

(72) Inventors: Claudia Figueiredo PEREIRA, San Jose, CA (US); Carlota Cunha MATOS, Sao Domingos de Rana (PT); Anna Claire PASSERNIG, Austin, TX (US); Kevin HU, Palo Alto, CA (US); Ana Margarida SANTIAGO, Vila Franca de Xira (PT); Rodrigo VIEIRA, Silveira (PT); Paul Michael FLEMING, Sunnyvale, CA (US); João Manuel DE OLIVEIRA GARCIA DA FONSECA, Sunnyvale, CA (US)

(21) Appl. No.: 19/244,731

(22) Filed: Jun. 20, 2025

Related U.S. Application Data
(60) Provisional application No. 63/761,538, filed on Feb. 21, 2025.

(51) Int. Cl. B01L 7/00

(52) U.S. Cl. CPC B01L 7/52; B01L 2200/16; B01L 2300/0816; B01L 2300/0864; B01L 2300/14

(57) ABSTRACT

A cartridge is described. The cartridge may include a substrate having a plurality of wells arranged along a flow path, a first subgroup of dried Mastermix reagents contained within a first well of the plurality of wells, a second subgroup of dried Mastermix reagents contained within a second well of the plurality of wells, and a third subgroup of dried Mastermix reagents contained within a third well of the plurality of wells. Collectively, the Mastermix reagents in the first subgroup, the second subgroup, and the third subgroup may include all reagents needed for performing nucleic acid amplification.

### CROSS-REFERENCE TO RELATED APPLICATION(S)

This application claims priority to U.S. Provisional Application No. 63/761,538, filed on Feb. 21, 2025, which is incorporated by reference herein in its entirety.

### TECHNICAL FIELD

The present disclosure relates generally to the integration of reagents, such as reagents that serve as Mastermix components for nucleic acid amplification, into a solid cartridge substrate for room-temperature storage. Aspects of the disclosure are drawn to the stabilization of the reagent formulation for compatibility with dry-down processes and to obtain the necessary assay performance and shelf-life. Aspects of the disclosure are also drawn to layouts for dispensing and drying Mastermix components to prevent denaturation of critical reagents (e.g. enzymes). Aspects are also drawn to a microfluidic circuit design configured to facilitate reagent integration and effective rehydration of these reagents, which may then be used for various reactions, such as for isothermal amplification of RNA markers.

### BACKGROUND

Molecular diagnostic devices, in particular point-of-care devices or point-of-care cartridges, may require the use of dried reagents contained within a device to ensure assay integration and reagent stability during the product shelf-life, as some reagents are incompatible with liquid storage at room temperature or at a cold temperature for the cartridge self-life. These dried reagents are then ideally resuspended into a solution in a fast and efficient way for further processing. Such mixtures of dried reagents necessary for running an assay are often referred to as a “Mastermix.” The operation of some devices may require the resuspension of Mastermix solutions into an elution buffer containing the analytes to be measured.

A first problem with integrating dried reagents, such as Mastermix reagents, into devices is the denaturation of enzymes due to the drastic increase of salt concentrations during the process of drying the reagents. The liquid form of a Mastermix solution includes salts at the range of concentrations required to enable its operation, specifically enzyme functionality. As this liquid solution is being dried, the effective salt concentration in the dried residue may gradually increase so as to cause irreversible enzyme denaturation, due to the removal of water molecules from the surface of those proteins. Accordingly, there is a need for an efficient method of drying a mixture of reagents that inhibits the denaturing of enzymes. Specifically, there is a need for a method having conditions and configurations for drying reagents, such as Mastermix solutions, used in molecular diagnostic products.

A second problem with currently available devices containing dried reagents, such as Mastermix reagents, is that they are unable to achieve the efficient and timely resuspension of the dried reagents. Available processes for fast homogenization, such as liquid shuffling or robust mixing, may lead to undesired fluidic effects, such as bubbling or discontinuous flow, which, in the case of reagents for nucleic acid amplification, generally result in inefficient amplification of nucleic acids in the downstream circuits. Accordingly, there is a need for improved processes and configurations for controlled resuspension and mixing.

The present disclosure is directed to overcoming one or more of these above-referenced challenges

### SUMMARY OF THE DISCLOSURE

The disclosure includes, for example, a cartridge. The cartridge may include a substrate having a plurality of wells arranged along a flow path, a first subgroup of dried Mastermix reagents contained within a first well of the plurality of wells, a second subgroup of dried Mastermix reagents contained within a second well of the plurality of wells, and a third subgroup of dried Mastermix reagents contained within a third well of the plurality of wells. Collectively, the Mastermix reagents in the first subgroup, the second subgroup, and the third subgroup may include all reagents needed for performing nucleic acid amplification.

According to some aspects of the disclosure, the third subgroup may contain reagents having a salt concentration that is higher than a salt concentration of at least one of the first subgroup or the second subgroup. The third subgroup may contain reagents having a salt concentration that is higher than a salt concentration of the first subgroup, and the first or the second subgroup may contain at least one enzyme that denatures when exposed to the salt concentration of the third subgroup. The third subgroup may contain reagents having a salt concentration that is higher than a salt concentration of the first subgroup, and the first subgroup may contain at least one enzyme that denatures when exposed to the salt concentration of the third subgroup, and the second well may be spaced between the first well and the third well along the flow path. The plurality of wells may each have a width of approximately 2.5 mm to approximately 4.5 mm and a depth of approximately 50 μm to approximately 450 μm. The plurality of wells may include a plurality of first wells, a plurality of second wells, and a plurality of third wells. The first well may not be directly next to the third well, and the first well may be positioned upstream relative to the third well along the flow path. The first subgroup may include nucleic acid polymerase and reverse transcriptase. The second subgroup may include at least one of fluorescence dye and deoxyribonucleotide triphosphates. The third subgroup may include magnesium sulfate, a buffer, and a salt.

The disclosure also includes, for example, a method of forming a cartridge to be used for nucleic acid amplification. The method may include dispensing a first droplet of a first solution into a first well arranged along a flow path of the cartridge, dispensing a second droplet of a second solution into a second well arranged along the flow path of the cartridge, dispensing a third droplet of a third solution into a third well arranged along the flow path of the cartridge, and drying the first droplet, the second droplet, and the third droplet. The first solution may contain a first subgroup of Mastermix reagents, and the first droplet may make contact with walls of the first well when the first droplet is received within the first well. The second solution may contain a second subgroup of Mastermix reagents, and the second droplet may make contact with walls of the second well when the second droplet is received within the second well. The third solution may contain a third subgroup of Mastermix reagents, and the third droplet may make contact with walls of the third well when the third droplet is received within the third well. Collectively, the Mastermix reagents in the first subgroup, the second subgroup, and the third subgroup may include all reagents needed for performing nucleic acid amplification.

According to some aspects of the disclosure, drying may include at least one of (i) exposing the first droplet, the second droplet, and the third droplet to a low-humidity air flow, or (ii) vacuum drying the first droplet, the second droplet, and the third droplet. A volume of the first droplet of the first solution dispensed into the first well may be approximately 1.50 μL to approximately 7.50 μL. A volume of the second droplet of the second solution dispensed into the second well may be approximately 1.50 μL to approximately 9.30 μL. A volume of the third droplet of the third solution dispensed into the third well may be approximately 1.50 μL to approximately 6.00 μL. A plurality of first droplets may each be dispensed into one of a plurality of first wells, a plurality of second droplets may each be dispensed into one of a plurality of second wells, and a plurality of third droplets may each be dispensed into one of a plurality of third wells. The third subgroup may contain reagents having a salt concentration that is higher than a salt concentration of the first subgroup, and the first subgroup may contain at least one enzyme that denatures when exposed to the salt concentration of the third subgroup. The third subgroup may contain reagents having a salt concentration that is higher than a salt concentration of the first subgroup, the first subgroup may contain at least one enzyme that denatures when exposed to the salt concentration of the third subgroup, and the third droplet may not be dispensed into a well of the plurality of wells that is directly next to a well of the plurality of wells into which a first droplet is dispensed. The first subgroup may include nucleic acid polymerase and reverse transcriptase. The second subgroup may include at least one of fluorescence dye and deoxyribonucleotide triphosphates. The third subgroup may include magnesium sulfate, a buffer, and a salt.

The disclosure also includes, for example, a method of rehydrating a plurality of subgroups of dried Mastermix reagents. The method may include introducing a fluid into a flow path of a cartridge. A plurality of wells may be arranged along the flow path. A first well along the flow path may contain a first dried subgroup of Mastermix reagents, a second well along the flow path may contain a second dried subgroup of Mastermix reagents, and a third well along the flow path may contain a third dried subgroup of Mastermix reagents. Collectively, the Mastermix reagents in the first subgroup, the second subgroup, and the third subgroup may include all reagents needed for performing nucleic acid amplification. A salt concentration of the third subgroup may be higher than a salt concentration of the first subgroup and the second subgroup. The fluid may be introduced first into at least one of the first well or the second well to rehydrate at least the dried first subgroup or the dried second subgroup, respectively, before being introduced into the third well to rehydrate the third subgroup.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary device with which a cartridge according to the present disclosure may be used, according to one or more embodiments.

FIG. 2 depicts a cartridge for use with the device of FIG. 1, on which embodiments of the disclosure may be included, according to one or more embodiments.

FIG. 3 depicts a portion of the cartridge of FIG. 2 including an exemplary Mastermix well chamber layout, according to one or more embodiments.

FIG. 4 depicts a series of wells for storing exemplary Mastermix reagents, according to one or more embodiments.

FIGS. 5A-5C each depict a graph summarizing exemplary experimental results, according to one or more embodiments.

FIGS. 6A-6C each depict a graph summarizing exemplary experimental results, according to one or more embodiments.

FIGS. 7A-7B depict a series of wells for storing exemplary Mastermix reagents, according to one or more embodiments.

FIGS. 8A-8C each depict a graph summarizing exemplary experimental results, according to one or more embodiments.

FIGS. 9A-9D each depict a graph summarizing exemplary experimental results, according to one or more embodiments.

FIGS. 10A-10B each depict an exemplary arrangement of wells storing Mastermix reagents, according to one or more embodiments.

FIG. 10C depicts a graph summarizing exemplary experimental results associated with the arrangement of wells of FIGS. 10A-10B, according to one or more embodiments.

FIG. 11A depicts a schematic of an exemplary Mastermix fluid well, according to one or more embodiments.

FIG. 11B depicts a schematic of an exemplary Mastermix fluid well configuration, according to one or more embodiments.

FIG. 12 depicts a scale for a Mastermix fluid well, according to one or more embodiments.

FIGS. 13A-13D depict example fluid well arrangements for storing exemplary Mastermix reagents on a portion of a cartridge, according to one or more embodiments.

FIG. 14 depicts alternative arrangements of Mastermix reagents in the wells of FIGS. 13A-13D.

FIG. 15 depicts an example workflow for an RNA-based assay using dried reagents, according to one or more embodiments.

FIG. 16 depicts a portion of a cartridge according to FIG. 2, including an exemplary Mastermix well chamber layout according to FIG. 3.

As used herein, the terms “comprises,” “comprising,” “includes,” “including,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “or” is inclusive and is intended to mean that a process, method, article, or apparatus that comprises a list of elements may include a combination of or all of the elements. The term “exemplary” is used in the sense of “example,” rather than “ideal.” In addition, the terms “first,” “second,” and the like, herein do not denote any order, quantity, or importance, but rather are used to distinguish one element or a structure from another. For example, a well described as being a first well positioned along a flow path does not ascribe a particular order to the first well or limit it to being physically positioned in a sequentially first location, but instead is used as a term to merely distinguish a particular well out of a plurality of wells for reference. Moreover, the terms “a” and “an” herein do not denote a limitation of quantity, but rather denote the presence of one or more of the referenced items. Further, as used herein, the terms “about,” “substantially,” and “approximately” generally mean +/−10% of the indicated value.

Notably, for simplicity and clarity of illustration, certain aspects of the figures depict the general structure and/or manner of construction of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments. For example, one of ordinary skill in the art appreciates that the side views are not drawn to scale and should not be viewed as representing proportional relationships between different components. The side views are provided to help illustrate the various components of the depicted assembly, and to show their positioning relative to one another.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Current reagent integration approaches for Mastermix-type reagent formulations tend to focus on lyophilization as a standard approach. Lyophilization is an effective way to preserve reagent functionality but involves great complexity in terms of the manufacturing process and lyophilized reagent handling during downstream device manufacturing processes. This is generally due to the possibility of destabilization of the lyophilized composition and consequent loss of reagent functionality if not kept in very low humidity environments. Lyophilization thus presents clear limitations in integration into complex, multi-component and multi-material devices. The presented concepts address one or more of these limitations with improved Mastermix reagent formulation and integration methods for subsequent processing and storage.

The current disclosure provides a method for formulation of reagents, device designs for dispensing, drying, and rehydrating those reagents, and a method to rehydrate the dried reagents effectively. The features are presented in detail below and include know-how from areas spanning reagent development, manufacturing process development, microfluidic device, and assay integration.

One embodiment of the disclosure is drawn to a method of drying reagents, such as reagents included in Mastermix solutions, that are used in molecular diagnostic products. The drying methods are designed to maintain enzymatic viability while promoting the long-term stability of the reagents. Drying may be necessary, because the reagents needed for an assay may be unstable when in a wet solution. As a result, long-term storage of wet solutions on a cartridge for use in a molecular diagnostics product may not be viable. Methods of the disclosure may include the strategic separation of the Mastermix solution into a plurality of subgroups, each containing a subset of component reagents, and then adding stabilizers to enhance compatibility with the drying process for integration in a cartridge product. For example, depending on the number and type of reagents included in a given Mastermix solution, the Mastermix solution may be separated into two, three, four, five, or more subgroups of reagents, and then each subgroup may be dried and stored separately within wells that are arranged along a flow path of a substrate. Another embodiment of the disclosure may present a device design for dispensing the subgroups of reagents, e.g., those reagents associated with a Mastermix solution used in molecular diagnostic products, onto a substrate to promote enzymatic viability and functional molecular biology assay performance while positioning its dried subgroups of components in a microfluidic circuit designed in such a way so as to promote fast and uniform resuspension while maintaining enzymatic activity. Another embodiment of the disclosure is drawn to a method for reagent rehydration and homogenization using the device described above.

Exemplary Systems with which Embodiments of the Disclosure May be Used and Incorporated

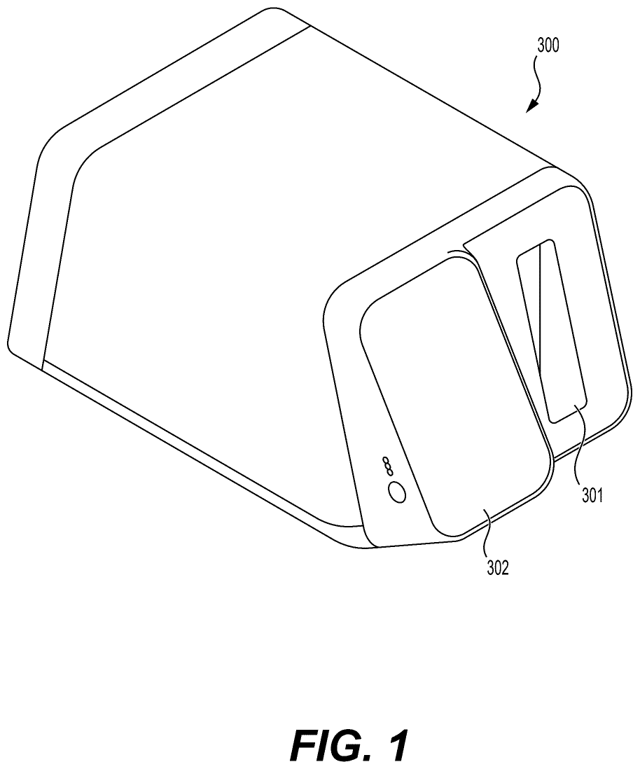

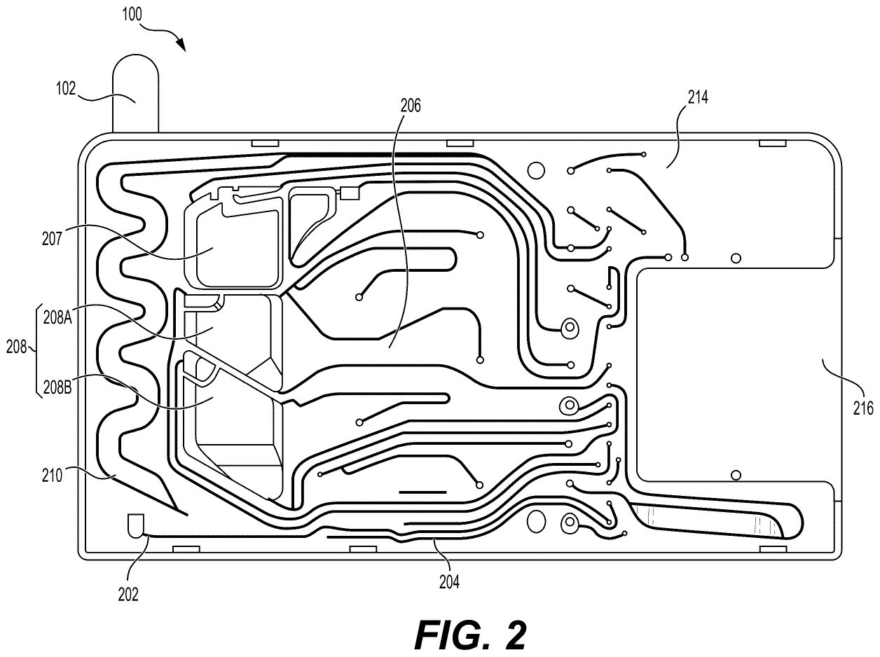

FIG. 1 depicts instrument 300 configured to determine expression levels of subcomponents (e.g., biomarkers) from a biological sample of a subject, in order to generate a composite biomarker that can be used to characterize the biological sample. Instrument 300 may include a slot 301 configured to receive fluidic device 100, in the form of a cartridge, shown in FIG. 2 and described herein. Instrument 300 may further include an optional display panel 302. An optional display panel 302 can be configured to display information related to the processing of the biological sample and/or diagnosis of a disease, disorder, or condition based on the information obtained from the biological sample. For example, the display panel may allow a user to choose a type of program used for processing the biological sample. The display panel 302 can include architecture with input controls to allow a user to input other information as needed, for example a sample ID or other patient clinical or demographic information. In some embodiments, the display panel 302 can include architecture for displaying the result after the biological sample is processed. In some embodiments, the display panel 302 can include architecture for displaying the diagnosis result based on information obtained from the biological sample being processed. In some embodiments, the display panel 302 can include a touchscreen and a control menu (e.g., as input subsystems) allowing a user to make configurations. Alternatively or additionally, other input devices, such as keys, buttons, knobs, etc., may be included as input mechanisms. In some embodiments, the instrument 300 can be configured to communicate wirelessly with another device and/or software application, such as a cell phone, computer, and/or a mobile application. In some embodiments, the instrument 300 may be configured to be controllable through a mobile application, computer, and/or a cell phone. It should be understood that instrument 300 is described herein for context only, and embodiments of the disclosure may be used with any suitable cartridge-compatible device or any device with which dry reagents may be stored or used.

FIG. 2 depicts fluidic device 100, also referred to herein as a cartridge. Suitable cartridges and devices with which they may be used are disclosed, for example, in U.S. Patent Publication No. 2024/0132963A1, herein incorporated by reference in its entirety. In embodiments, the fluidic device 100 can include a sample holder 104, shown in broken lines, that is configured to hold one or more biological samples to be tested. In embodiments, the biological sample can be loaded into an internal sample container that is built into the fluidic device 100. In embodiments, the biological sample may be contained in a sample container 102 (e.g., a collection tube, vial, etc.) that is inserted into fluidic device 100. In some embodiments, sample container 102 may be external from fluidic device 100. In some embodiments, the sample container 102 can be removable from fluidic device 100. In some embodiments, the sample container 102 may be a vial, a tube, a bottle, or a cup. In some embodiments, the sample container 102 can be a vacuum blood collection tube. The sample container 102 can contain (e.g., be pre-packaged, be combined with the biological sample prior to coupling the sample container 102 to the fluidic device 100) one or more additives. In some embodiments, the biological sample is subject to processing before being loaded into the sample container 102. In some embodiments, the biological sample is not subject to processing before being loaded into the sample container 102. In still other embodiments, the sample contained in sample container 102 may be emptied from the sample container 102 into the fluidic device 100, e.g., in the sample holder 104, and sample container 102 may not be inserted into fluidic device 100.

In some embodiments, the fluidic device 100 can include a conduit 202 which functions to transfer the biological sample out of the sample container 102 or the sample holder 104. In some embodiments, the biological sample can be drawn into the conduit 202 (e.g., through capillary force, through applied pressure, etc.) and transferred to another component of the fluidic device 100 through a channel, an example of which is shown as 204. Fluidic devices of the disclosure can have a plurality of channels that facilitate the flow of fluid inside the fluidic device between different compartments. A fluid may include a biological sample, reagent solution, gas, water, air, or a combination thereof.

In some embodiments, the fluidic device can include one or more reaction chambers 208 downstream of the sample container 102 and a reagent storage zone 214. While the majority of the disclosure will focus on reagent storage zone 214, the rest of fluidic device 100 is described briefly in order to provide context. In some aspects, the reaction chamber 208 may be fluidly coupled to one or more channels and positioned downstream of reagent storage zone 214 for conveying the biological sample and one or more reagents from the reagent storage zone 214 into the reaction chamber 208. In some embodiments, the reaction chamber 208 can include one or more reaction compartments as needed to perform one or more reactions on the fluidic device 100. In some embodiments, the reaction chamber 208 may comprise a plurality of reaction compartments, e.g., for performing multiplexed assays in parallel. For example, the reaction chamber 208 may include reaction compartments 208A, 208B.

In some embodiments, the biological sample may flow from the sample container 102 to a reaction chamber where the biological sample is processed. In some embodiments, a pump or pneumatic assembly may facilitate the transfer of the biological sample from the sample container 102 to the reaction chamber 208.

In some embodiments, a predefined volume of the biological sample can be driven or otherwise flow (e.g., under capillary effect) from a metering compartment 210, which may be structured to control metering of a volume of the biological sample into the fluidic device 100 for processing, through the reagent storage zone 214 to the reaction chamber 208. The reagent storage zone 214 can include one or more reagents, for example, reagents useful in processing the biological sample. In some embodiments, the reagents may be stored in fluidic device 100 in dried form and may be rehydrated as a liquid biological sample flows through the reagent storage zone 214. Details of the reagent storage zone 214 are described further herein. Where analysis of nucleic acids from the biological sample is desired, the reagent storage zone 214 can include reagents for nucleic acid extraction (e.g., extraction of RNA, DNA, gDNA, mtDNA, bacterial DNA, mRNA, miRNA, cfRNA, cfDNA, ribosomal RNA, etc.) from the biological sample. The reagent storage zone 214 can include any suitable amount or concentration of reagent needed for nucleic acid extraction. In some embodiments, the amount or concentration of reagent may depend on the volume of biological sample to be processed. The volume of the biological sample to be processed may be determined by the metering compartment 210.

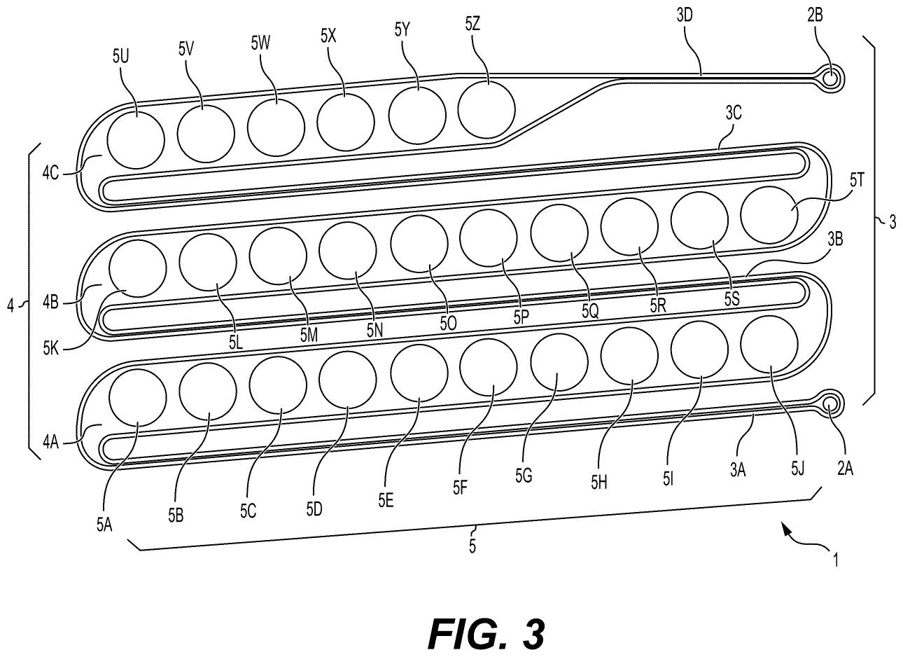

In some embodiments, the mixture of biological sample and one or more reagents may flow to the reaction chamber 208. The mixture of biological sample and reagents may undergo one or more processing steps in the plurality of reaction compartments (e.g., 208A, 208B). In some aspects, the reagent storage zone 214 may include wet reagents, e.g., stored in blisters (not shown) in order to process the biological sample, for example extract nucleic acids, although the disclosure will focus on details of dry reagent storage on instrument 100. Example wet reagents include, but are not limited to, lysis, wash, and reaction buffers with the appropriate concentrations of salts, surfactants, enzymes, and/or solvents such as ethanol and isopropanol. In some embodiments, the one or more wet reagents may flow from the blisters to a reaction chamber 208 through a channel of the fluidic device. As described above, reagent storage zone 214 may contain the dry Mastermix reagents necessary to carry out at least a portion of the function of fluidic device 100 when used with instrument 300; alternatively, reagent storage zone 214 may include a region including a variety of chambers configured to store dry reagents. One example of the dry reagent portion of reagent storage zone 214 is chamber 1, depicted in FIG. 3. The dry reagents may be arranged within chamber 1 so as to facilitate efficient dehydration and rehydration, as will be further described.

While examples of cartridges and devices with which the cartridges may be used are described with relation to FIGS. 1 and 2 to provide context, the embodiments described herein are not limited to such use cases. Cartridges may take any suitable form and may be used with any suitable devices in order to perform an assay. Thus, the term ‘cartridge’ as used herein refers to a substrate having a plurality of wells arranged along a flow path, in which subgroups of Mastermix reagents are contained. Prior to use and during storage, the Mastermix reagent subgroups contained within the wells are dried in order to promote stability.

### Preparation of Dry Reagent Formulations

One aspect of the disclosure is drawn to a method of formulating combinations of reagents for nucleic acid amplification in order to make the reagents compatible with a drying process. The drying process may allow for dried-down storage of the reagents for longer periods of time, e.g., on a cartridge, as described above, at non-refrigeration temperatures, such as room temperature (about 55 degrees Fahrenheit to about 80 degrees Fahrenheit), or at refrigeration temperatures down to about 32 degrees Fahrenheit, while maintaining functionality upon rehydration. Dried reagents capable of being stored at room temperature may reduce the energy storage requirements and portability of the cartridge.

The combinations of reagents may cooperatively make up a Mastermix solution. The Mastermix solution may serve as a pre-prepared mixture containing all necessary components for a particular enzymatic reaction, which in some of the embodiments described herein, may be the basis for nucleic acid amplification. The term ‘Mastermix’ is used across molecular biology applications to refer to any mixture of components required for a reaction to occur. Thus, while the description herein discusses a Mastermix for nucleic acid amplification, the concepts described herein may be used for any suitable Mastermix to be used with other reactions. In the case of a Mastermix used for nucleic acid amplification, the Mastermix may include, e.g., one or more of a reverse transcriptase enzyme for converting RNA into complementary DNA (cDNA), a DNA polymerase for DNA amplification, magnesium ions as a cofactor, dNTPs (deoxynucleotide triphosphates) as building blocks, intercalating fluorescent dye, and a buffer system to maintain pH and ionic conditions.

According to embodiments of the disclosure, in order to dry the Mastermix, the Mastermix may be divided into a plurality of subgroups of reagents, each containing a subset of the reagents in the Mastermix formulation. A subset of reagents may include one or more different types of reagents. Depending on the number or types of reagents included in a Mastermix, different numbers of subgroups may be used, for example, two, three, four, five, or more subgroups. In some embodiments, Mastermix solutions having a high salt concentration may be stored separately from enzymes to inhibit denaturization of the enzyme. Reagent compatibility and formulations may be taken into account. In some embodiments, the number of subgroups may be determined by the volumes of each Mastermix required to reach a final desired concentration, as well as the target volumes of a dispensed solution. In the example embodiment described herein for the purposes of illustration, three subgroups are used.

In this example, the components of the Mastermix may be dried down in three different subgroups with excipients to facilitate long-term storage at non-refrigeration temperatures, e.g., room temperature. It may be desirable to dehydrate the Mastermix relatively quickly to inhibit the loss of reagent stability over time. In some aspects, reagents may be exposed to low humidity airflow, which may be at warm temperatures or room temperatures. Examples of low humidity airflow may include one or more of hot air ovens, room temperature hair flow, or low humidity air flow in a vacuum. The drying process may include one or more steps. For example, a first drying step may include drying the surface of the droplet. In some aspects, the first drying step may be performed quickly, e.g., on the order of seconds. In some aspects, the first step may be performed in under 5 seconds, under 4 seconds, under 3 seconds, under 2 seconds, or under 1 second. A second drying step may gradually decrease the humidity in the environment surrounding the droplet to dehydrate the interior composition of the droplet. In some embodiments, the second step has a longer duration than the first step. In some embodiments, a smaller starting volume of the droplet may decrease the time required to dry the droplet. In some embodiments, an increased surface area of a droplet may similarly decrease the time required to dry the droplet.

The Mastermix may be rehydrated with, e.g., components of the biological sample. For example, the Mastermix may be rehydrated with eluted nucleic acids, such as eluted RNA, prior to partitioning the combined sample and Mastermix reagents into separate reactions in order to promote uniform reaction conditions in each amplification well. Thus, aspects of the disclosure are drawn to the separation of reagents into different subgroups and the addition of excipients for dried-down stability. Table 1, below, shows the division of an example Mastermix into three subgroups:

TABLE 1
Mastermix formulation into subgroups

| | Representative | Concentration | |
|---|---|---|---|
| Reagent group | components | ranges | Function |
| Group 1 | DNA Polymerase | 0.3-0.6 U/uL | Enzymes for one-step |
| Mastermix | Glycerol free reverse | 0.08-0.14 U/uL | reverse transcription and |
| | transcriptase | | amplification process |
| Group 2 | dNTP | 1.19-1.61 mM | dNTPs are used for |
| Mastermix | Fluorescence dye (e.g. | 3.58-4.42 mM | synthesizing new strands of |
| | Syto9) | | DNA |
| | | | SYTO9 is the intercalating |
| | | | fluorescent dye used to |
| | | | indicate the increase in target |
| | | | copies amplified |
| Group 3 | Magnesium sulfate | 7.2-9.6 mM | The buffer is used to |
| Mastermix | Surfactant (e.g. Tween | 0.1-0.5% by | maintain pH and provide ions |
| | 20) | volume | necessary for polymerase |
| | Buffer (e.g. Tris-HCL, | 2.05-33.15 mM | activity, and Magnesium ions |
| | Tris-Base) | 81-117 mM | serve as cofactor for the |
| | Salt (e.g. Potassium | | enzymatic reaction |
| | Chloride) | | |

In the above example, the three groups of Mastermix were optimized in order to (a) contain the concentrations of all reagents necessary for nucleic acid amplification, (b) result in a liquid with surface tension compatible with a plastic substrate, as used in the testing described herein, such that it allows for droplet containment without wetting outside of the droplet wells, and (c) contain the necessary concentration of excipient to promote stability through the dry-down process without preventing complete dry-down and without interfering with functionally in the amplification reaction. The exact Mastermix described above is exemplary, and it is noted that a change, e.g., in the substrate material types with which the testing will be performed, may result in a modification of the Mastermix components or concentrations.

Besides the division of Mastermix components into a plurality of subgroups, in this example, three subgroups, the addition of excipients, such as trehalose, may promote stability of the reagents through the drying down process and through the storage period of the final product at non-refrigeration, e.g., room temperature, while not interfering negatively with the nucleic acid amplification reaction. For the reagent groups in the example above, an optimal concentration of excipient was defined in the range of about 0.1-2.0% by weight. Instead of, or in addition to, trehalose, one or more other excipients, such as lactose, dextran, sucrose, pullulan, glycerol, or polyethylene glycol (PEG) may be used as stabilizers in the formulation process. As an example, glycerol is commonly used as a stabilizer for enzyme formulations in order to maintain functionality of the enzyme through cold storage.

Stability of the dried subgroups of reagents described above in Table 1 was preliminarily assessed during initial testing over the course of 72 hours, however longer-term stability is intended. Long-term stability may be on the order of months or years, for example, at least about 6 months, at least about 9 months, at least about 12 months, at least about 18 months, at least about 24 months, or at least about 36 months. Example stability may be achieved in the range of about 6 months to about 36 months, about 9 months to about 36 months, about 12 months to about 36 months, about 18 months to about 36 months, about 6 months to about 24 months, about 9 months to about 24 months, about 12 months to about 24 months, about 18 months to about 24 months, about 6 months to about 12 months, about 9 months to about 12 months, etc.

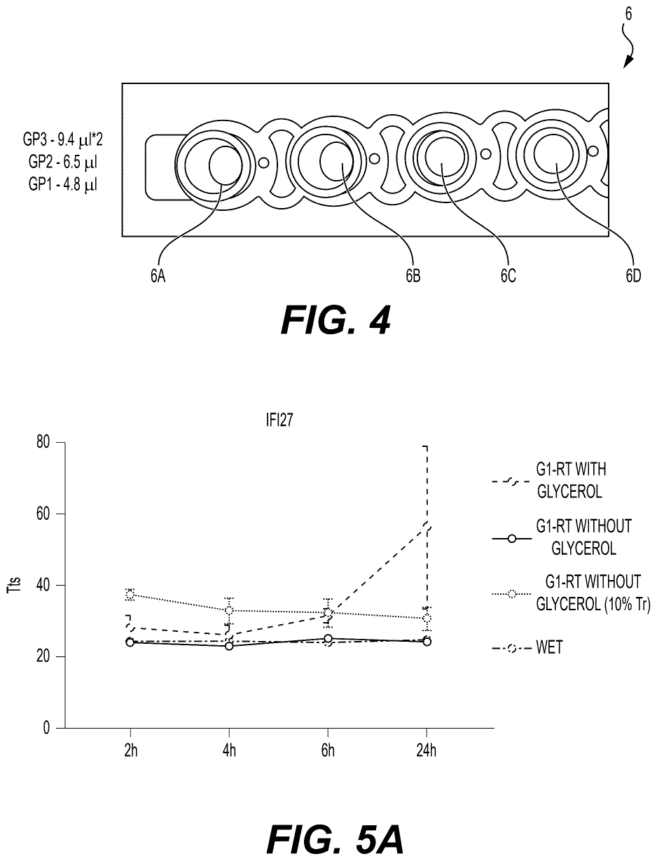

FIGS. 4-9D summarize some experiments that were performed in order to inform the reagent formulation determination. These figures and the accompanying descriptions provide representative datasets that supported specific formulation decisions. The data depicted were obtained during preliminary reagent formulation and drying experiments. Tests were performed on different substrates and while screening different formulations and excipient combinations, with performance being assessed upon resuspension shortly after drying and over longer periods of time to evaluate the stabilization capability of the excipient concentrations used. Different formulations were assessed for functional performance after rehydration as well as post-drying stability, in order to determine the ultimate Mastermix component formulations that would be used.

### Reagent Dry-Down and Formulation

Other aspects of the disclosure are drawn to a device for integration of the reagents, once separated into subgroups, onto a substrate to achieve optimal drying down, and to maintain reagent performance and achieve effective rehydration. The substrate may be plastic, glass, metal, or any other suitable materials, e.g., hydrophobic materials. The substrate may be incorporated as part of a larger cartridge, such as the cartridge of FIG. 2, described briefly above. The device includes a plurality of wells to contain individual reagent droplets and a Mastermix chamber for rehydration of these integrated reagents.

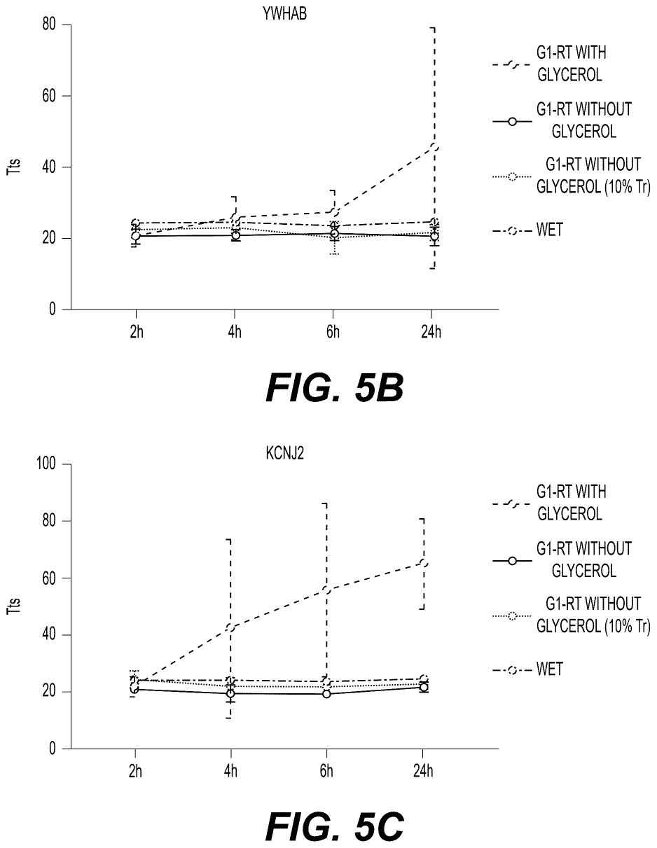

As described below, FIGS. 5A-9D and 10C summarize the results of experiments that were performed during formulation determination, as representative datasets that supported specific formulation decisions, and are discussed below. The data depicted were obtained in preliminary reagent formulation and drying experiments. Tests were performed on different substrates and screening different formulations and excipient combinations, with performance being assessed upon resuspension shortly after drying and over longer periods of time to evaluate the stabilization capability of the excipient concentrations used. Different formulations were assessed for functional performance immediately after drying and rehydration, as well as post-drying stability over a period of time, in order to determine the suitable Mastermix component formulations for both assay performance and compatibility with device stability.

FIG. 4 depicts a plurality of wells 6, including wells 6A, 6B, 6C, 6D, in the form of polymerase chain reaction (PCR) caps that are configured to permit the amplification of material. Wells 6A, 6B contain Group 3 Mastermix, as indicated in Table 3 below. The drop size in this experiment for the Group 3 Mastermix was 9.4 μL in each well 6A and 6B. Well 6C contained a 6.5 μL drop of the Group 2 Mastermix. Well 6D contained a drop of 4.8 L of the Group 1 Mastermix. The actual and target fill volume of the wells may impact the rate of dehydration of the Mastermix solutions; additionally or alternatively, the target volume or the wells may vary based on the liquid utilized to rehydrate the Mastermix solutions and/or the biological sample used.

FIGS. 5A, 5B, and 5C each depict the results of preliminary testing that was performed to evaluate the impact of drying time and the use of a reverse transcriptase (RT) enzyme with and/or without a stabilizer and preservative on a loop-mediated isothermal amplification (LAMP) reaction. Glycerol was used as a stabilizer and preservative for the enzymes used. At least four Mastermix reagent solutions were evaluated to determine the stability of the Group 1 Mastermix solution with and without glycerol: RT enzyme with glycerol, RT enzyme without glycerol, RT enzyme without glycerol and with 10% trehalose by weight as a stabilizer, and a wet Mastermix solution (i.e., not previously dried). To perform the experiment, which further assessed whether 10% trehalose by weight was necessary to maintain stability over time, Group 1, 2, and 3 Mastermix solutions were dried in a drying chamber on PCR caps for a duration of either 2 hours, 4 hours, 6 hours, and 24 hours. The Mastermix solutions were rehydrated in the following sequential order: Group 3, Group 2, and Group 1. Approximately 1 minute of waiting time was observed after rehydrating the Mastermix solutions, followed by 3 up-down mix. LAMP reactions with 2 μL solution using dried primers was then performed using each of the rehydrated Mastermix solutions. The LAMP primer mixes included interferon alpha-inducible protein 27 (IFI27), tyrosine 3-monooxygenase/tryptophan 5-monooxygenase activation protein beta (YWHAB), and potassium inwardly rectifying channel subfamily J member 2 (KCNJ2).

As shown in FIG. 5A, interferon alpha-inducible protein 27 (IFI27) was evaluated for each test group at each drying time. Time to threshold (Tts) was used to assess the LAMP product for each test group, as is shown plotted on the y-axis in FIG. 5A. The time to threshold of the RT enzyme without glycerol and the wet solution were relatively constant at approximately 20 across the 2-, 4-, 6-, and 24-hour drying times evaluated. The time to threshold of the RT enzyme without glycerol with 10% trehalose decreased over the evaluated drying intervals from approximately 40 Tts at 2 hours of drying time to approximately 30 Tts at 24 hours of drying time. The time to threshold of the RT enzyme with glycerol rose from approximately 30 Tts at 2 hours of drying time to approximately 55 Tts at 24 hours of drying time.

As shown in FIG. 5B, tyrosine 3-monooxygenase/tryptophan 5-monooxygenase activation protein beta (YWHAB) was evaluated for each test group at each drying time. The time to threshold of the RT enzyme without glycerol and the RT enzyme without glycerol with 10% trehalose were relatively constant at approximately 20 Tts across the 2-, 4-, 6-, and 24-hour drying times evaluated. The wet solution was relatively constant at approximately 25 Tts across the drying times evaluated. The time to threshold of the RT enzyme with glycerol rose from approximately 20 Tts at 2 hours of drying to approximately 45 Tts at 24 hours of drying.

As shown in FIG. 5C, potassium inwardly rectifying channel subfamily J member 2 (KCNJ2) was evaluated for each test group at each drying time. The time to threshold of the RT enzyme without glycerol, the RT enzyme without glycerol with 10% trehalose, and the wet solution were each relatively constant across the drying times evaluated. The time to threshold of the RT enzyme with glycerol rose from approximately 20 Tts at 2 hours of drying to approximately 65 Tts at 24 hours of drying.

The experiment, the results of which are shown in FIGS. 5A-5C, suggested that the RT enzyme without glycerol was more stable upon drying, showing minimal impacts on the LAMP reaction, even at 24 hours of drying. The data suggested that increasing the amount of trehalose may not be beneficial.

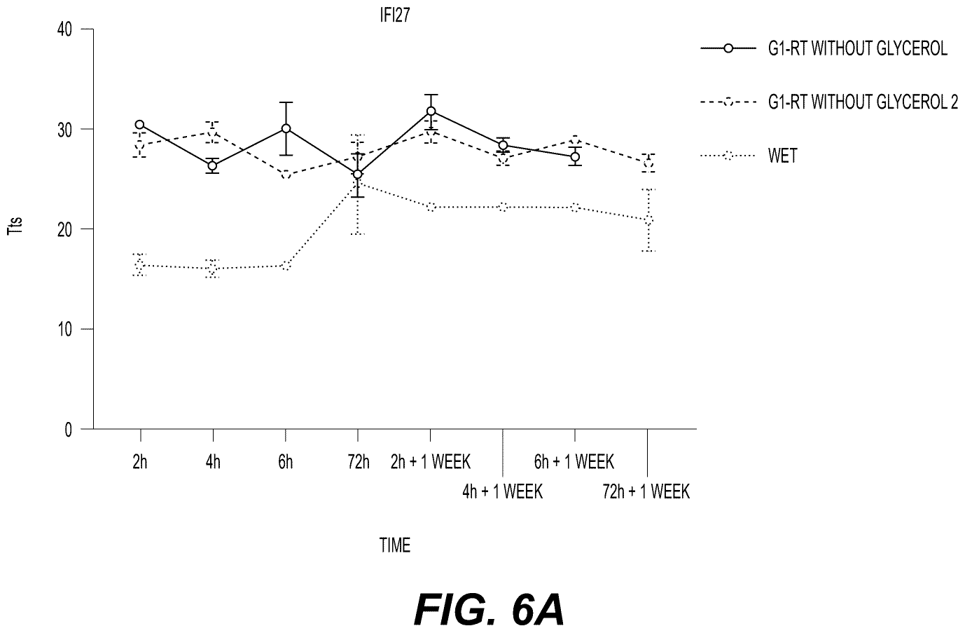

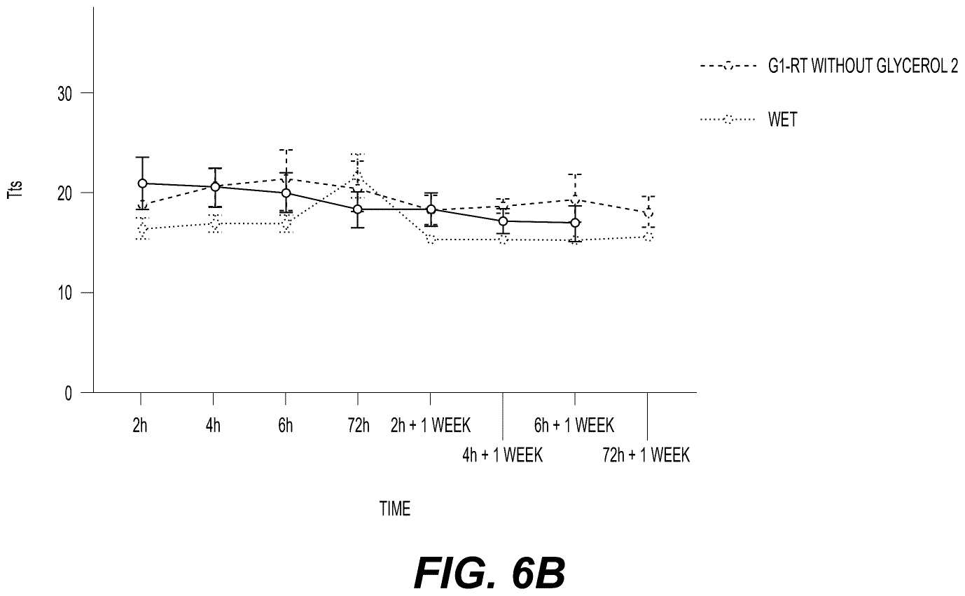

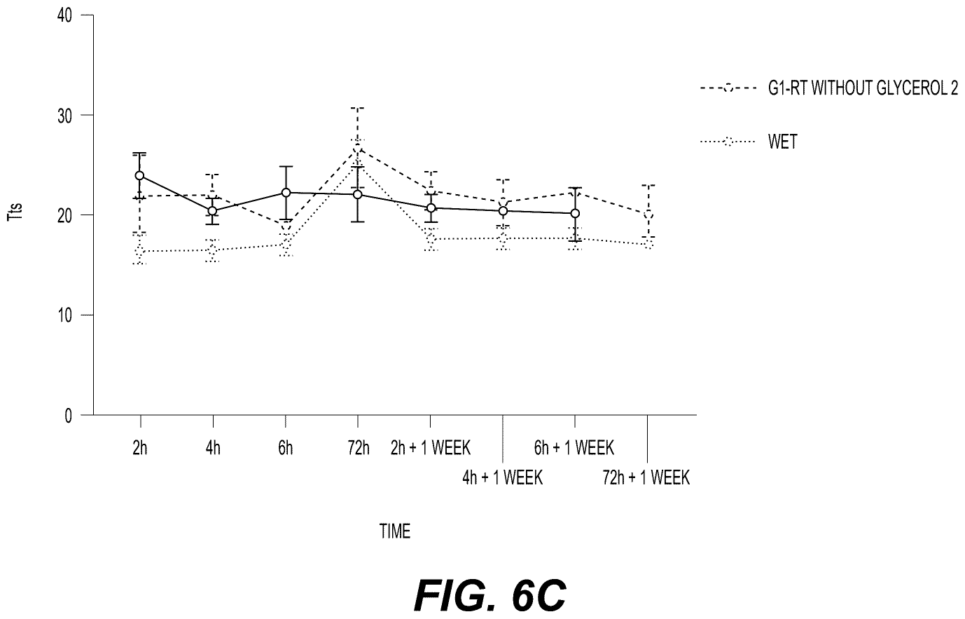

FIGS. 6A, 6B, and 6C each depict the results of testing performed to evaluate the stability after drying down Mastermix groups in the drying chamber for different periods of time. To perform the experiment, Group 1, 2, and 3 Mastermix solutions were deposited in PCR caps as described above in reference to FIG. 4. for The Group 1, 2, and 3 Mastermix solutions were dried for either 2 hours, 4 hours, 6 hours, or 72 hours in the drying chamber and stored for 1 week at room temperature. The Mastermix solutions were then rehydrated in the following sequential order: Group 3, Group 2, and Group 1. Approximately 1 minute of waiting time was observed after rehydrating the Mastermix solutions. LAMP reactions with 2 μL solution using dried primers was then performed using each of the rehydrated Mastermix solutions. The LAMP primer mixes included IFI27, YWHAB, and KCNJ2. Three solutions were evaluated: a first RT enzyme without glycerol, a second RT enzyme without glycerol, and a wet Mastermix solution that had not previously been dried.

As shown in FIG. 6A, IFI27 was evaluated for each experimental Mastermix solution after drying for 2 hours, 4 hours, 6 hours, and 72 hours, as well as after the same increments of drying time plus storage for one week. Time to threshold (Tts) was used to assess the LAMP product for each test group, as is shown plotted on the y-axis in FIG. 6A. The Group 1 RT enzyme without glycerol and the Group 2 RT enzyme without glycerol were relatively similar to one another and relatively constant over all time intervals. The wet solution increased from approximately 17 Tts at the 2-hour, 4-hour, and 6-hour drying time intervals to approximately 22 Tts at the 72-hour drying time interval. As shown in FIG. 6A, storage for one week after drying across all time intervals resulted in a Tts of about 21.

As shown in FIG. 6B, YWHAB was evaluated over the various drying time intervals and one-week storage timepoints. The first RT enzyme without glycerol and the second RT enzyme without glycerol were relatively constant over all drying time internals at approximately 20 Tts. The wet solution was relatively constant at approximately 17 Tts across all drying time intervals, with a slight increase at the 72-hour drying time interval. At the 72-hour drying time interval, the Tts of the wet solution increased to approximately 21 Tts before decreasing to approximately 16 Tts for the one week of storage time intervals.

As shown in FIG. 6C, KCNJ2 was evaluated over the various drying time intervals and one-week storage timepoints. The first RT enzyme without glycerol was relatively constant over all drying time internals at just over 20 Tts. The second RT enzyme without glycerol showed a bit more variability at the 6-hour and 72-hour time points, but was otherwise relatively constant. The wet solution was relatively constant at approximately 16 Tts across all timepoints, with the exception of the 72-hour drying time interval, when the Tts of the wet solution increased to approximately 25 Tts.

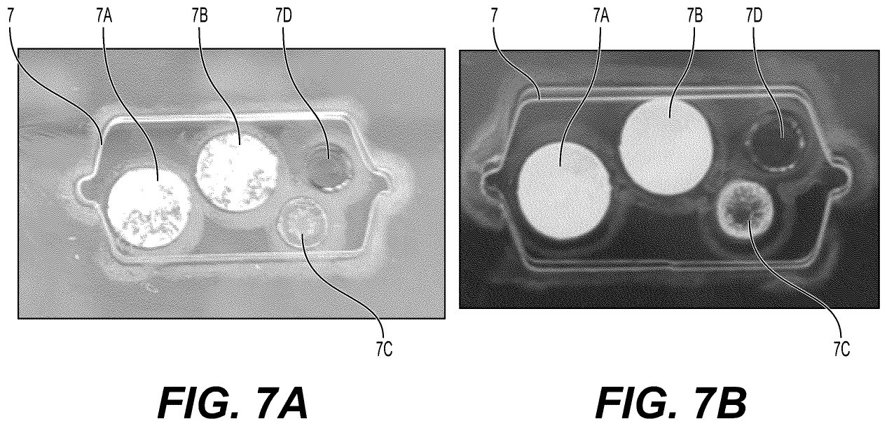

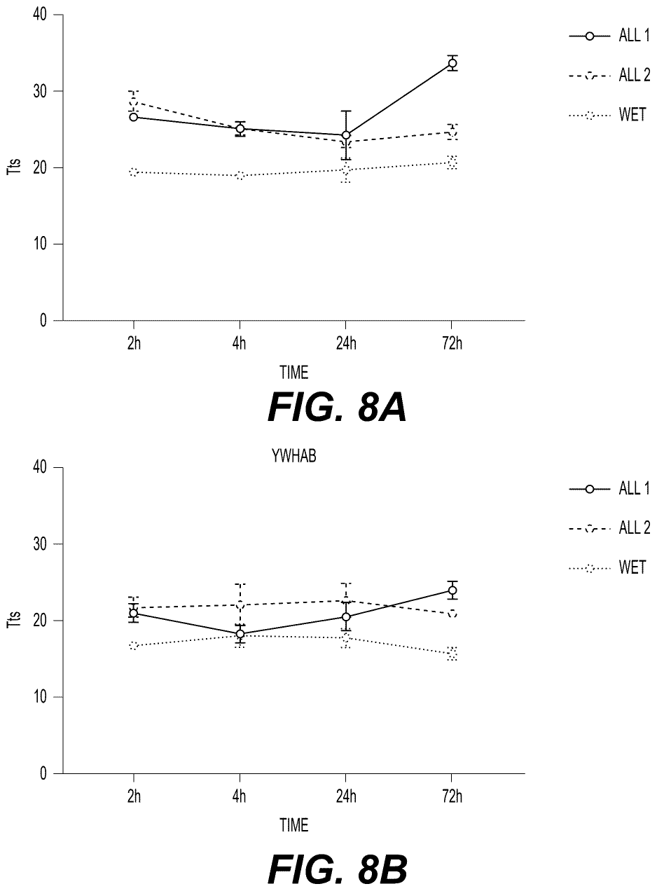

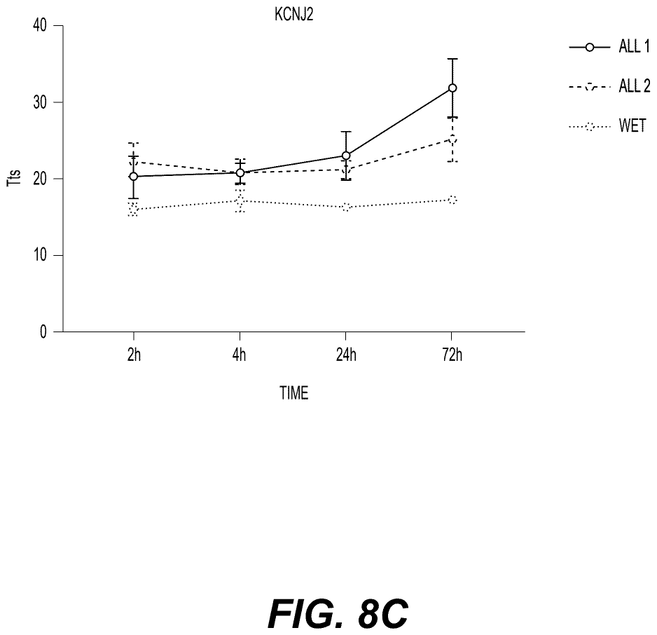

FIGS. 7A through 8C depict the results from experiments performed to assess the effect of drying down on reagent activity and to evaluate the long-term stability of Mastermix solutions dried in a drying chamber. FIG. 7A and FIG. 7B depict an alternative arrangement of the drying configuration of the Mastermix solutions. FIG. 7A depicts the dried Mastermix Groups 1, 2, and 3 after 24 hours. FIG. 7A depicts a plurality of wells, collectively referred to as wells 7, that includes wells 7A, 7B, 7C, 7D. Wells 7A, 7B contain Group 3 Mastermix. FIG. 7B depicts the dried Mastermix Groups 1, 2, and 3 in wells 7A, 7B, 7C, 7D after 72 hours. FIGS. 8A-8C depict the results of the experiment.

To perform the experiment, Group 1, 2, and 3 Mastermix solutions were dried on the substrates for either 2 hours, 4 hours, 24 hours, or 72 hours. The Mastermix solutions were then rehydrated in the following sequential order: Group 3, Group 2, and Group 1. Approximately 1 minute of waiting time was observed after rehydrating the Mastermix solutions. LAMP reactions with 2 μL solution using dried primers was then performed using each of the rehydrated Mastermix solutions. The LAMP primer mixes included IFI27, YWHAB, and KCNJ2. Three solutions were evaluated: a first RT enzyme of Groups 1-3 mixed together, a second RT enzyme of Groups 1-3 mixed together, and a wet Mastermix solution.

As shown in FIG. 8A, IFI27 was evaluated for each experimental Mastermix solution after drying for 2 hours, 4 hours, 24 hours, and 72 hours in the drying chamber. Time to threshold was used to assess the LAMP product for each test group, as is shown plotted on the y-axis in FIG. 8A. In the experiment, the time to threshold was determined for each of the intervals of drying time, described above. The first RT enzyme and the second RT enzyme gradually decreased from approximately 28 Tts at 2 hours to approximately 25 Tts at 24 hours. The first RT enzyme mixture increased to approximately 34 Tts at 72 hours, whereas the second RT enzyme mixture remained relatively constant at approximately 25 Tts at 72 hours after rehydration. The increase for the first RT enzyme at the 72-hour drying time may have been irregular due to the use of less resuspension time for that data point. The wet solution gradually increased from approximately 19 Tts at 2 hours to approximately 21 Tts at 72 hours.

As shown in FIG. 8B, YWHAB was evaluated for each experimental Mastermix solution after drying for 2 hours, 4 hours, 24 hours, and 72 hours. Time to threshold was again used to assess the LAMP product for each test group, as shown plotted on the y-axis. The first RT enzyme and the second RT enzyme resulted in approximately 21 Tts at 2 hours. The first RT enzyme dropped to approximately 18 Tts at 4 hours and increased to approximately 23 Tts at 72 hours after rehydration, which, as described above, may have been an irregular result. The second RT enzyme remained relatively constant across the drying time intervals, as did the wet solution.

As shown in FIG. 80, KCNJ2 was also evaluated for each of the experimental groups. The first RT enzyme and the second RT enzyme resulted in approximately 20 Tts and 22 Tts, respectively at 2 hours. The first RT enzyme dropped to approximately 20 Tts at 4 hours before increasing to approximately 31 Tts at 72 hours, which, for the reasons above, may have been an irregular result. The second RT enzyme remained relatively constant across the drying times in the range of approximately 20 Tts to approximately 22 Tts. The wet solution also remained relatively constant across drying times.

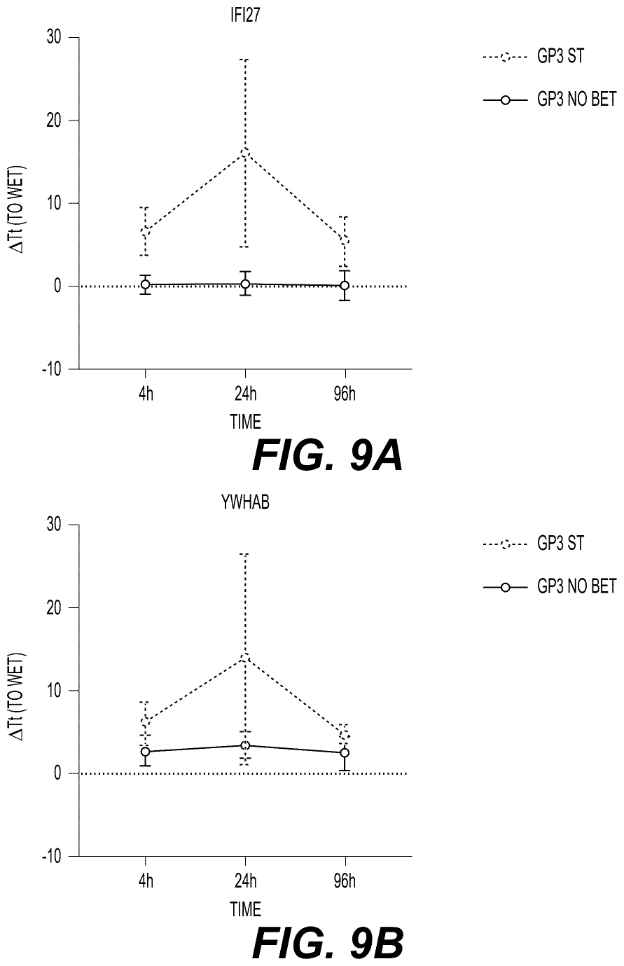

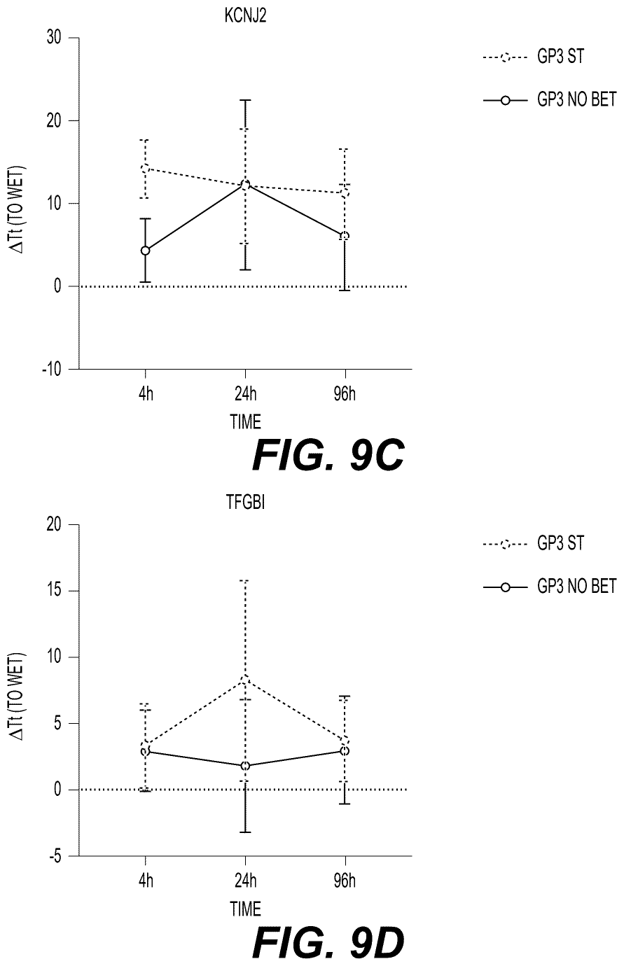

FIGS. 9A-9D depict the results of an experiment to determine the impact of removing betaine as an excipient from the Group 3 Mastermix solution in the drying process. To perform the experiment, Group 1-3 Mastermix solutions were dried on PCR caps for either 4 hours, 24 hours, or 96 hours in a drying chamber. LAMP was performed on 2 μL of solution using the dried primers and adjusting the amount of betaine such that the final concentration constitutes 0.8 M of solution, as is shown in Table 2, below.

TABLE 2
Volume and drop count from experiment
removing betaine as excipient

| | Drop volume (μL) | Total volume (μL) | Number of drops |
|---|---|---|---|
| G1 | 4.2 | 20.8 | 5.0 |
| G2 | 5.6 | 28.1 | 5.0 |
| G3 | 3.5 | 55.8 | 16.0 |
| Total | | | 26 |

As shown in FIG. 9A, IFI27 was evaluated for each experimental Mastermix solution after drying in a drying chamber for 4 hours, 24 hours, or 96 hours. In the experiment, the difference (e.g. delta (Δ)) between the time to threshold for the Mastermix solution and the time to threshold for the wet solution was plotted over the intervals of drying time described above. The difference is shown on the y-axis as ΔTts. The ΔTts for the Group 3 Mastermix solution with betaine versus the wet solution at 2 hours was approximately 7. The ΔTts for this same mixture was approximately 16 and 6 at 24 hours and 96 hours, respectively. At all time intervals from 2 hours to 96 hours, the Group 3 Mastermix solution without betaine versus the wet solution was approximately 0 ΔTts.

As shown in FIG. 9B, YWHAB was evaluated across the drying times. In the experiment, the difference (e.g. delta (Δ)) between time to threshold for the Mastermix solution and the time to threshold for the wet solution was plotted over the intervals of drying time described above. The difference is shown on the y-axis as ΔTts. The ΔTts for the Group 3 Mastermix solution with betaine versus the wet solution at 2 hours was approximately 7. The ΔTts for this same mixture was approximately 14 and 6 at 24 hours and 96 hours, respectively. At all time intervals from 2 hours to 96 hours, the ΔTts for the Group 3 Mastermix solution without betaine versus the wet solution was approximately 3.

As shown in FIG. 9C, KCNJ2 was evaluated across the drying times. The ΔTts for the Group 3 Mastermix solution with betaine versus the wet solution at 2 hours was approximately 14. The ΔTts for this same mixture was approximately 12 and 11 at 24 hours and 96 hours, respectively. The ΔTts for the Group 3 Mastermix solution without betaine versus the wet solution at 2 hours was approximately 4. The ΔTts for this same mixture was approximately 12 and 6 at 24 hours and 96 hours, respectively.

As shown in FIG. 9D, TFGBI (transforming growth factor beta induced) was evaluated for each experimental Mastermix solution after drying for 4 hours, 24 hours, and 96 hours. The ΔTts for the Group 3 Mastermix solution with betaine versus the wet solution was approximately 3, 8, and 3 at 4 hours, 24 hours, and 96 hours, respectively. The ΔTts for the Group 3 Mastermix solution without betaine versus the wet solution was approximately 3, 2, and 3 at 4 hours, 24 hours, and 96 hours, respectively.

As FIGS. 9A-9D demonstrate, the data suggest that removal of betaine from the Group 3 Mastermix during the dry down process results in less heterogeneity in LAMP, and there was a smaller difference between the wet solution and the Group 3 Mastermix solutions when betaine was removed.

### Reagent Rehydration

A microfluidic approach may be used for reconstitution of the dried reagents. Different droplet dispensing layouts may have a different functional impact on the assay outcome. For example, the salt concentration of certain reagents may, at least in part, affect where they should be positioned relative to other reagents. The reagents may be reconstituted in an order that takes into consideration the salt concentrations of the various reagents. In the tests performed, it was observed that Group 1 droplets (group droplets are defined in Table 1, above) should not be positioned next to and thus dispensed next to Group 3 droplets due to the high salt concentration in Group 3 being detrimental to enzyme functionality in Group 1. In this manner, the salt concentrations and their effect on enzyme functionality at least in part influences the dispensing layout of the Mastermix subgroups within a reagent portion of a cartridge. In some aspects, droplets of different Mastermix subgroups may be interspersed with one another to effectively pre-mix the reagents as they are rehydrated by the leading edge of the entering fluid. In general, the subgroups may be arranged along a flow path such that the concentration of the rehydrated solution created as the rehydrated subgroups mix gradually increases in salt concentration. An example reagent subgroup layout of the Mastermix chamber of a device is shown in Table 3, below. The well numbers indicate the order in which the wells are arranged along the microfluidics flow path, as shown in FIG. 3.

TABLE 3
Example of reagent layout on the Mastermix chamber

| | | Approximate Target Fill |
|---|---|---|
| Well | Reagents | Volume (μL) |
| 5A, 5C, 5E, 5G | Group 1 Mastermix | 1.50-7.50 |
| 5B, 5D, 5F, 5H | Group 2 Mastermix | 1.50-9.30 |
| 5I-5Z | Group 3 Mastermix | 1.50-6.00 |

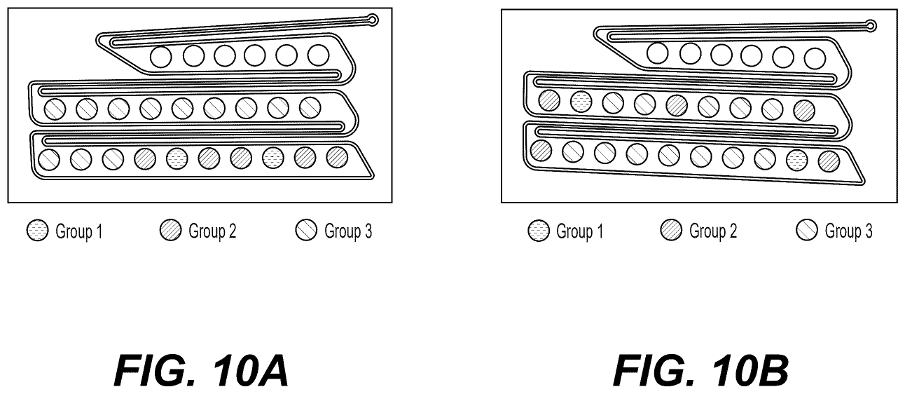

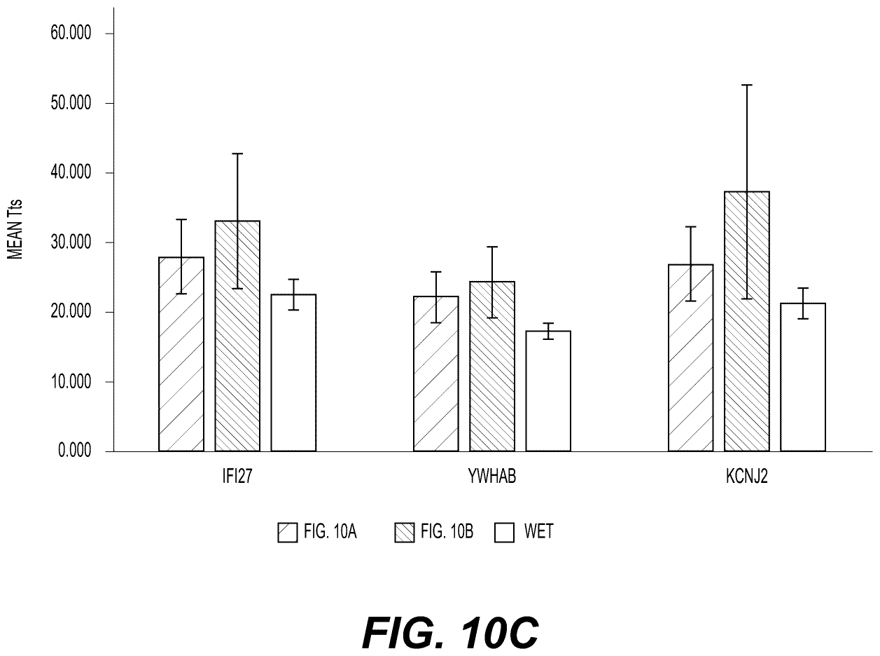

The relative arrangement of reagent subgroups having high salt concentrations and reagent subgroups including reagents that may be affected by high salt concentrations (e.g., by denaturing), may be an important factor to consider when determining the subgroup layout. For example, with reference to FIG. 3 and Table 3, even if the droplets are not in contact when they are contained in their individual wells, the fact that gradual rehydration of Group 1 occurs in the vicinity of Group 3 droplets was shown to result in impaired enzyme functionality (FIG. 10C, discussed further below). As a result, reagent subgroups having high salt concentrations (in this example, Group 3) may be contained in wells spaced further away along a flow path from wells containing reagent subgroups having enzymes that are sensitive to high salt concentrations (in this example, Group 1), with one or more wells containing subgroups that may act as a buffer (in this example, Group 2) positioned in between along the flow path. Intervening buffer subgroups may gradually introduce the high salt concentration reagent subgroup to the low salt concentration reagent subgroup during rehydration to inhibit denaturing of the enzymes within the low salt concentration reagent subgroup. In some aspects, subgroups of different types may be interspersed with one another so as to gradually increase the overall salt concentration of the rehydrated reagent solution as the various reagent subgroups are rehydrated along a flow path.

With reference now to FIG. 3, an example of a Mastermix chamber layout is shown with droplet containment wells. A subgroup of Mastermix reagents, as described above, may be contained within each of the droplet containment wells. For example, during manufacturing of a cartridge, a subgroup of Mastermix reagents in solution may be aliquoted into each droplet containment well and then dried.

Accordingly, a dried subgroup of Mastermix reagents may be stored in each well. FIG. 3 depicts a layout of a chamber 1 in which the wells may be arranged. Chamber 1 may be included as part of a larger cartridge, e.g., chamber 1 may be located within reagent storage zone 214 or may be equivalent to reagent storage zone 214 described above with reference to FIG. 2.

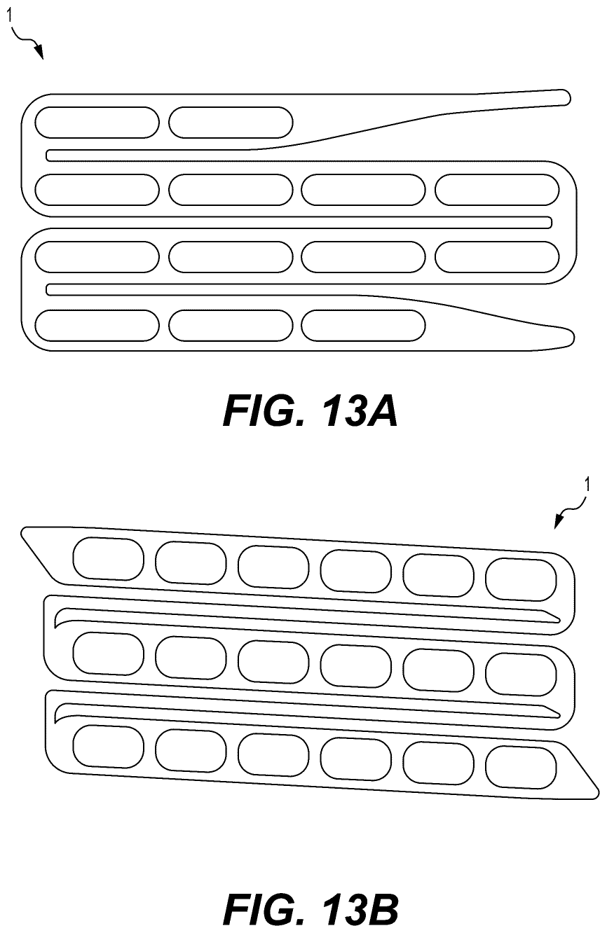

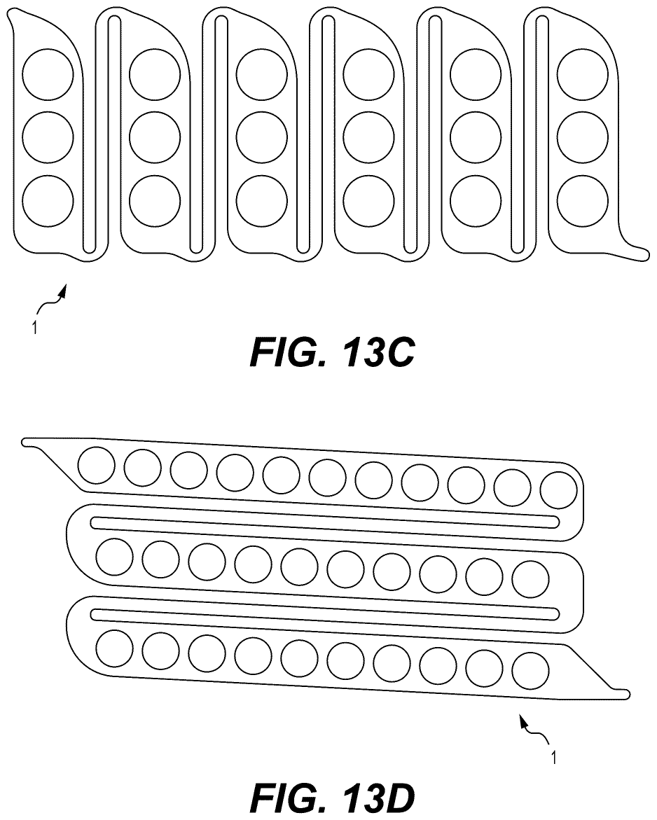

Chamber 1 may include a plurality of wells arranged relative to one another along a fluid flow path. in some embodiments, chamber 1 may include at least about 5, at least about 10, at least about 15, at least about 20, or at least about 25 wells. For example, chamber 1 may include about 5 wells to about 50 wells, about 10 wells to about 50 wells, about 20 wells to about 50 wells, about 5 wells to about 40 wells, about 10 wells to about 40 wells, about 20 wells to about 40 wells, about 20 wells to about 30 wells, etc. In the exemplary chamber 1 depicted in FIG. 3, chamber 1 includes wells 5A, 5B, 5C, 5D, 5E, 5F, 5G, 5H, 5I, 5J, 5K, 5L, 5M, 5N, 5O, 5P, 5Q, 5R, 5S, 5T, 5U, 5V, 5W, 5X, 5Y, 5Z (e.g., wells 5A-5Z, collectively referred to herein as wells 5). An individual well 5 may have the same diameter or different diameter as another well 5. An individual well 5 may have the same depth or different depth as another well 5. Wells 5 may be disposed along a flow path 3. Flow path 3 may include a plurality of arms, with each arm having a plurality of wells 5 disposed along it, and a plurality of channels, which may fluidly connect each arm. For example, in the exemplary flow path of FIG. 3, flow path 3 includes channel 3A, 3B, 3C, 3D that fluidly connect arms 4A, 4B, 4C in a serpentine arrangement. Although four channels and three arms are depicted in FIG. 3, any suitable number or combination of arms and channels may be used, and, indeed, alternative arrangements are depicted below, e.g., in FIG. 13C.

Wells 5 may be arranged along arms 4A, 4B, 4C or may be separated by channels 3A, 3B, 3C, 3D according to the contents of individual wells 5A-5Z. For example, in some embodiments, well 5A and well 5B may be arranged adjacent to each other to permit the contents of well 5A and the contents of well 5B to mix more readily with one another during rehydration. Alternatively or additionally, wells 5A and 5C may be arranged comparatively further away from each other to inhibit the contents of well 5A and the contents of well 5C from mixing as readily during rehydration. Channels 3A, 3B, 3C, 3D and arms 4A, 4B, 4C along flow path 3 may be disposed between port 2A and port 2B, which mark the ends of the flow path 3.

Ports 2A, 2B may receive fluid to rehydrate the dehydrated Mastermix solutions disposed in chamber 1. For example, in some embodiments, fluid may be added to port 2A. Fluid may flow from port 2A along channel 3A and into arm 4A. Arm 4A may contain wells 5A-5J. Fluid may flow from a first end of arm 4A where well 5A is disposed to a second end of arm 4A where well 5J is disposed. Fluid may then flow from the second end of arm 4A through channel 3B to arm 4B. Arm 4B may contain wells 5K-5T. Fluid may flow from a first end of arm 4B where well 5K is disposed to a second end of arm 4B where well 5T is disposed. Fluid may then flow from the second end of arm 4B through channel 3C to arm 4C. Arm 4C may contain wells 5U-5Z. Fluid may flow from a first end of arm 4C where well 5U is disposed to a second end of arm 4C where well 5Z is disposed. Fluid may flow from the second end of arm 4C through channel 3D to port 2B. Port 2B may be configured to permit the fluid to flow out of the chamber 1, e.g., to a reaction chamber.

In some aspects, fluid may flow along flow path 3 from port 2A to port 2B. In some embodiments, chamber 1 may be positioned so that port 2B is located above port 2A, and fluid may flow along flow path 3 from the bottom to the top. Fluid may be introduced from a bottom of each well 5, in addition to the flow of fluid from port 2A to port 2B. The flow of fluid along the flow path 3 may both rehydrate the subgroups of Mastermix reagents and may cause the controlled mixing of subgroups with one another so as to inhibit the denaturing of enzyme reagents, as described above and detailed further below. Experiments that were performed to inform the arrangement of Mastermix subgroups are now described.

FIGS. 10A and 10B depict sample layouts of well configurations along microfluidic flow paths. The layout of FIG. 10A may consist of an arrangement in the wells of Mastermix solutions along the flow path as follows: Group 2 Mastermix, Group 1 Mastermix, Group 2 Mastermix, and Group 3 Mastermix. The layout of FIG. 10B may consist of a repeating arrangement in the wells of Mastermix solutions as follows: Group 2, Group 1, Group 3, Group 2, Group 1, and Group 3. The shaded wells of FIGS. 10A and 10B represent Group 1, Group 2, and Group 3 in various shading patterns. The arrangement of the wells of the Mastermix reagents as shown in FIG. 10A may inhibit direct contact between Group 1 and Group 3 reagents during rehydration by utilizing Group 2 reagents as a buffer. The arrangement of the wells of the Mastermix reagent subgroups as shown in FIG. 10B may promote efficient rehydration of the reagent subgroups while maintaining the activity of the various reagents.

In some embodiments, the buffer reagents (in this example, Group 2 reagents) utilized should be properly rehydrated prior to contacting the Group 1 and/or Group 3 reagents. In some instances, the Group 2 reagents may be contained in wells that are interspersed with wells containing one or more other reagent subgroups so that, as rehydration occurs, the resulting solutions does not become oversaturated with Group 2 buffer reagents, causing some Group 2 reagents to fall out of solution and diluting the buffering effect of the reagents.

As described above, FIG. 10C depicts the effects of drying down the Mastermix solutions and using trehalose and magnesium sulfate (MgSO₄) in higher concentrated stock solutions, and the impact of the same on LAMP assays. In the experiment, Mastermix subgroups were dried on chips for four hours in a drying chamber in either the arrangement shown in FIG. 10A or the arrangement shown in FIG. 10B. After rehydration, LAMP was performed in 2 μL reactions using dried primers. The LAMP primer mixes included IFI27, YWHAB, and KCNJ2.

The results depicted in FIG. 10C were obtained in preliminary reagent layout experiments and demonstrate that different subgroup layouts resulted in different functional performance. The dried Mastermix subgroups arranged as shown in FIG. 10A appeared more similar to wet Mastermix solutions and showed less loss in precision and time to threshold. When viewing the bar chart of FIG. 3, lower bars, and thus faster reaction time is desirable, as well as lower standard deviation bars, to promote replicability. Higher bars may indicate a salt concentration that is potentially too high and thus may be detrimental to enzyme function.

The Mastermix wells (for example, those shown in FIG. 3, and FIGS. 10A-10B) having a serpentine arrangement may be included in a sealed packaging, e.g., a blister packaging. In some examples, each well may be individually sealed so as to inhibit cross-contamination during storage. When inserting the cartridge and packaging into a microfluidics device, such as the one in FIG. 1, the packaging may be punctured or otherwise opened to allow for rehydration of the Mastermix reagents.

Aspects of the disclosure are drawn to a method of arranging the specific subgroups of Mastermix reagents, such as Mastermix reagents used in molecular diagnostic products, so that they maintain enzymatic viability after drying, while also positioning its dried components in a microfluidic circuit designed in such a way so as to promote fast and uniform resuspension at the time the assay is conducted. The arrangement of the reagent subgroups, e.g., in this case, three reagent subgroups, in the containment wells is selected so as to promote effective rehydration, as will be described in further detail below. The dimensions of the channel and droplet containment wells is also selected so as to promote effective rehydration. The wells serve for anchoring the reagent drops when wet, to ensure repeatability of the drop size and liquid height. This may result in repeatability of the outcome of the drying process for each reagent group and consequently in the robustness of the final resuspension process and reagent functionality.

Droplet volume specification was performed taking into account the necessary amount of each reagent component that had to be introduced in the device in order to perform the relevant assay, and also considering the solubility in water of each component and the optimal ratio of Mastermix components for the intended reaction, in this case, a nucleic acid amplification reaction. Reducing or increasing these components beyond a certain range of concentrations may be detrimental to the reaction, e.g., the amplification reaction. For example, increasing the concentration of the enzymes and/or the individual components of the reagent may decrease their stability.

In addition, the optimal droplet size to obtain reproducible dispensing and droplet containment and the available space for droplet dispensing and distribution also impacted volume specifications. For example, too high of a concentration of a reagent may impair the ability to accurately pipette or otherwise dispense the droplets into the wells. Further, it may not be desirable to oversaturate the droplet solution. The wells serve to anchor the reagent drops when wet, as well as to ensure repeatability of the drop size and liquid height. The drop volumes may be selected so that when the drops are received within their respective wells, the drops have a consistent height and size to promote consistent drying speed and concentration. Droplets that are too tall or large may not properly dry within the wells, leaving the inner portions of the droplet wet, and thus decreasing the stability of the reagents. Droplets that are too small may dry too quickly, thus increasing the risk of denaturing of the enzymes and decreasing the stability of the components of the reagents. Further, droplets that are too small may not contact opposing sides of the wells, and thus may dry unevenly within the wells, which may also impair rehydration. The formulations were specifically adjusted to obtain the necessary volumes and contact angle with the surface, which was a plastic surface in the examples described herein, such that the droplets could be contained and anchored to the well outline, while maintaining all the necessary components in the correct concentrations. Smaller droplet size promotes efficient drying of the reagents, and thus smaller well sizes were chosen to compliment the droplet size within the well.

Surface tension may also impact the droplet formulation. A droplet that is too hydrophobic may maintain its spherical shape and may have a high ratio of volume to surface area. Such a droplet may be harder to dry throughout and may not sufficiently adhere to the walls of the well. A droplet that has too little and is too hydrophilic may not be sufficiently confined within a well. Smaller droplets may be utilized with the introduction of a tensoactive agent (e.g., TWEEN, e.g., at a concentration of approximately 0.01%) to reduce the droplet surface tension. In some aspects, a solvent, such as a TWEEN solution, may be used to increase the volume of a droplet so as to properly anchor within a well. The size and formulation of droplets utilized may include considerations of one or more of the ability to dispense the droplet into a well, the ability to anchor the droplet within the well, the solubility and stability of the droplet solution, the drying time required to sufficiently dry the droplet, and the efficiency of rehydration of the droplet once dried within the well.

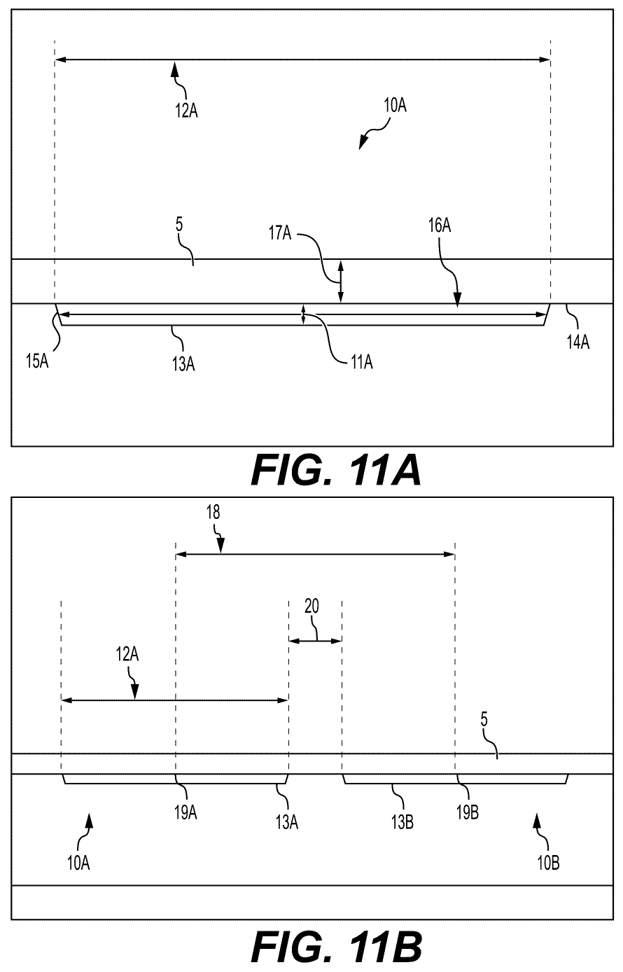

The design of the chamber 1 may include particular dimensional characteristics, as illustrated in FIG. 11A and FIG. 11B. FIG. 11A is a schematic cross-sectional view of a single reagent well for droplet containment. Well 10A may have a depth 11A, the depth 11A extending into a surface 14A to a bottom surface 13A, and a diameter 12A. In one embodiment, the depth 11A of well 10A in combination with well diameter 12A may promote droplet anchoring for the different reagent groups and droplet volumes. In some aspects, the sidewall 15A of well 10A may have a gradual slope to promote droplet anchoring, in tandem with the droplet characteristic considerations discussed above. In some embodiments, sidewall 15A may form an obtuse angle with bottom surface 13A to increase the contact surface of a reagent droplet with sidewall 15A. Accordingly, internal diameter 16A of the well 10A may decrease as depth 11A increases. Such dimensions may allow the reagent droplet to be in contact with the wall of the circular well across the entirety of the well perimeter. This may inhibit droplet misplacement and height variation, e.g., if the droplet did not touch the walls of the well, the height of the droplet may be dependent on the contact angle between the droplet and the substrate, while if the droplet was all on one side of the well, uneven drying may result across the droplet, which may in turn impact reagent stability.

In some aspects, bottom surface 13A of well 10A may be micro-structured in a way that increases surface area in contact with the liquid, favoring uniform liquid adhesion to the well. For example, bottom surface 13A of well 10A may have increased roughness or other geometries, which may be on the order of tens of microns in depth. In some aspects, depth 11A of well 10A may be shallow enough to promote effective drying and rehydration through droplet surface exposure to the flowing liquid as rehydration occurs prior to the assay performance. For example, depth 11A of well 10A may be at least about 20 times smaller than diameter 12A. In another aspect, a depth 17A of chamber 1 may be sized to promote the occurrence of laminar flow when rehydrating the reagents, leading to a more predictable and reproducible rehydration process. For example, a deep well may inhibit the complete washing of the dried reagents at the beginning. A deep well may also result in the formation of bubbles during rehydration. The size of each well may also need to complement the volume of reagent to be dispensed, because a large cake of dried reagents on the bottom of a well may take too long to dry during the drying process, or may result in incomplete drying, which may negatively affect stability. In some aspects, a large cake of dried reagent at the bottom of the well may also take too long to rehydrate, or may not rehydrate fully.

For example, two extremes of rehydration may be considered. At one extreme, all of the dried reagent may be washed with a rehydrating solution together, but this would result in the denaturing issues described above. At the other extreme, a very slow rate of washing could occur, but this may be impractical due to the length of time that would be required in order to run an assay. The testing described herein indicated that an ideal rehydration method would create a carpet of reagent that resuspends gradually, into a generally uniform solution. In some aspects, an amount of dried reagent in one or more wells may allow for a gradual mixing that avoids the issue of introducing too much salt at once.

Another design aspect of chamber 1 is the distance between individual wells and the spacing of the wells relative to one another. FIG. 11B is a schematic cross-sectional view showing the spatial relationship between two wells for droplet containment within chamber 1. The distance between the wells takes into account the risk of droplets in separate wells mixing upon dispensing of the droplet into the well before drying, which may be detrimental to reagent function. The distance between the wells may also take into account the space optimization necessary to fit all the droplets in the available substrate area. It is noted that although the dispensing of droplets of liquid subgroups into different wells, followed by drying, is described herein, it is contemplated that the different subgroups of reagents may be prepared and freeze dried and then positioned within the respective wells. In other words, previously dried subgroups of reagents may be placed into different wells along a flow path.

Well 10B may have a diameter that is approximately the same size as diameter 12A of well 10A. A distance 18 may be measured from a center point 19A of well 10A and a center point 19B of well 10B. Well 10A and well 10B may be spaced apart from one another by a distance 20. In some embodiments, distance 20 may be increased if well 10A and well 10B contain reagents that, when mixed, may cause undesirable reactions or denaturing of the reagents. Alternatively and/or additionally, distance 20 may be decreased if well 10A and well 10B contain reagents that may cause favorable reactions or do not cause denaturing of the reagents. Alternatively or additionally, distance 20 may increase when fewer wells 10A, 10B are disposed on chamber 1. As described above, wells 10A, 10B may be configured to promote consistent droplet height to promote stability of the reagents when drying and/or rehydrating. Distance 20 between center point 19A of well 10A and center point 19B of well 10B then results from diameter 12A and an optimal distance between well 10A and 10B that prevents droplet mixing. Distance 20 may decrease to accommodate a number of wells disposed on chamber 1. Chamber 1 may be configured to promote uniform well filling.

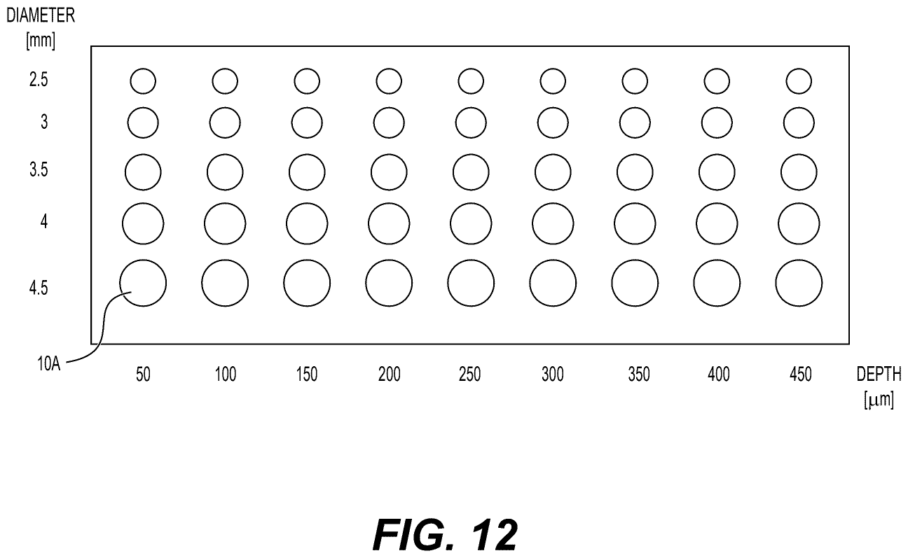

FIG. 12 depicts an example of a chip design used for well diameter 10A optimization. As shown in FIG. 12, diameter 12A of exemplary well 10A may be in the range of approximately 2.5 mm to approximately 4.5 mm; in the range from approximately 3 mm to approximately 4 mm; and/or approximately 3.5 mm. Depth 11A of exemplary well 10A may be in the range of approximately 50 μm to approximately 450 μm; in the range from approximately 100 μm to approximately 400 μm; 150 μm to approximately 350 μm; 200 μm to approximately 300 μm and/or approximately 250 μm.

The chamber for holding the dried Mastermix reagents may also be designed to promote robustness of the reagent rehydration process. The reagents may be sensitive and may need to be gently, but also effectively, rehydrated and mixed. While mixing of the reagents is needed for proper rehydration, the generation of air bubbles or air plugs is detrimental for the fluidic functionality of the assay and may result in poor homogenization of the Mastermix components and/or subsequent lack of amplification for some of the markers in the exemplary assays described herein.

FIGS. 13A-13D depict a number of alternative arrangements for chamber 1. These were tested with the above factors in mind in order to identify a chamber design that was able to address these challenges. The features described below, including filling direction, laminar flow, and manufacturability, were identified during this testing.

In some aspects, when determining the size and design of the Mastermix chamber, dimensions of the reagent wells may be considered, and, based on that, the size of the chamber may be determined, and then the flow rate may be defined based on the chamber layout and size, although any suitable manner of determining chamber arrangement and size may be used.

### Rehydration of Dried Reagents and Device Structure

Filling of the Mastermix chamber sections was found to be preferable when there was unidirectional flow. Unidirectional flow inhibited the occurrence of air bubbles in the circuit, which minimized variation in rehydration. The design of the final chamber 1 thus takes into account filling direction and the possible impact of gravity on the filling process and bubble management. The design also was selected such that the dimensions and geometry of the chamber varies smoothly, with minimal discontinuities. As discussed further below, the unidirectional flow of liquid into the chamber may occur from the bottom of the chamber up.

With respect to laminar flow, filling robustness may be enhanced with laminar flow at a relatively low Reynolds number, e.g., below 2000. This means at least one dimension of the chamber may remain short across all cross sections (typically depth), and the droplet wells may favor optimal droplet surface contact with the incoming liquid. In some aspects, channels with serpentine designs and rounded connections between rows of wells may be used in the chamber, to inhibit the creation of liquid discontinuities. FIGS. 13A-13D depict example chamber arrangements with curved, serpentine structures along which the wells are located. FIG. 13A depicts chamber 1 with a plurality of narrow oblong wells. FIG. 13B depicts an alternative chamber 1 with a plurality of wider oblong wells. FIG. 13C depicts another alternative arrangement of chamber 1 with a plurality of large circular wells. FIG. 13D depicts another alternative arrangement of chamber 1 with a plurality of small circular wells. In some embodiments, a combination of the well shapes and container configurations depicted in FIGS. 13A-13D may be used. These chambers designs were tested for controlled Mastermix rehydration.

Well dimensions and configurations also take into account the amount of space on the device that is available to accommodate the structure of the reagent storage and rehydration chamber, with the characteristics described above. Based on initial screening performed with numerous chamber designs, it was found that filling the chamber from the bottom may be beneficial, to allow for air to escape to the top of the chamber through a venting channel, while the serpentine-like designs provided continuity in the laminar flow rehydration process. It was also found that using rounded connections to inhibit the creation of liquid discontinuities was an ideal approach.

When considering manufacturability, the chamber design may ideally be amenable to reproducible and high-scale manufacturing, for example, using techniques such as injection molding of plastics and capping using bonded films onto the surface, using pressure-sensitive adhesives, or other bonding techniques, such as laser-welding, although other suitable techniques may be used.

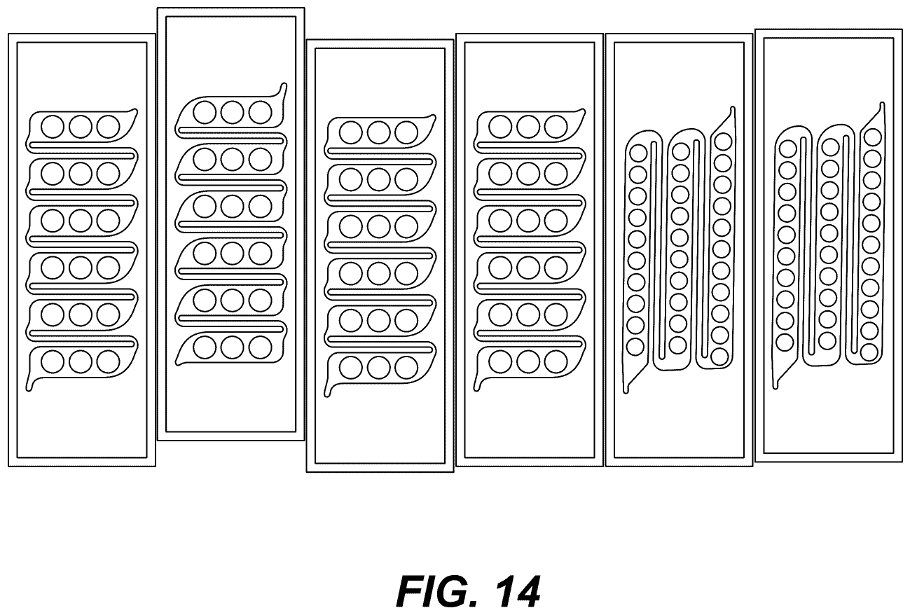

FIG. 14 depicts a plurality of chamber and the arrangements of Mastermix subgroups within the chamber, as represented by the shaded wells.

Aspects of the disclosure may relate to methods for rehydration of dried reagents within a microfluidic chamber to promote assay performance, including controlled filling of the Mastermix chamber device using fluid control, for example, using pneumatic actuation. For Mastermix rehydration, embodiments of the disclosure may take into account variations to flowrates, channel geometry, such as well depth, spacing, and diameter, and fluid movement within the chambers. The embodiments may also alter characteristics of the Mastermix reagent chamber to protect the integrity of the venting channels or gas ports to promote reproducible functionality of the system. Embodiments may also take into consideration pressure and time to fill the chamber, dwell time for rehydration, and pressurization of the Mastermix chamber.

The Mastermix chamber described above may be part of a larger cartridge design with multiple sections for performing different steps of an assay and/or assay preparation. The cartridge may include a Mastermix chamber as described herein, as well as other components, as will be described below. Fluid may pass through different sections of the cartridge during assay preparation and performance, and the Mastermix chamber may be one portion of that arrangement and overall performance.

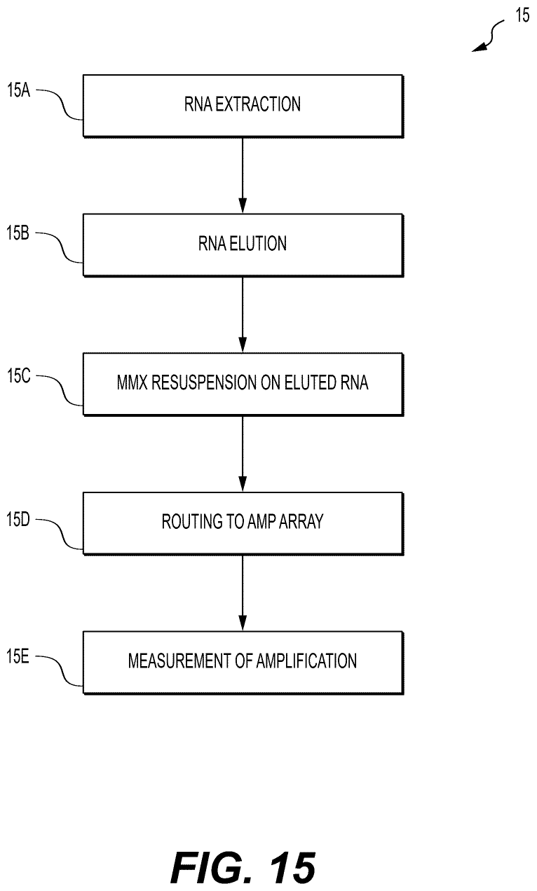

FIG. 15 depicts an example workflow 15 for an RNA-based assay using dried reagents, as an example of an assay that may be performed using the cartridge of FIG. 2 and device of FIG. 1. Workflow 15 may comprise a plurality of steps, including steps 15A, 15B, 15C, 15D, 15E. In one example, a liquid sample, e.g., a biological sample, such as a blood sample, may be inserted into the cartridge. In a first step 15A, RNA extraction from the liquid sample may occur in a portion of the cartridge, followed by RNA elution in a second step 15B. In a third step 15C, Mastermix rehydration may then occur in the reagent chamber, as described above, for example directly into the same solution containing the eluted RNA. Following resuspension and homogenization, during a fourth step 15D, the solution may be routed out of the reagent chamber described above to an amplification array. In a fifth step 15E, a measurement of amplification may be taken.

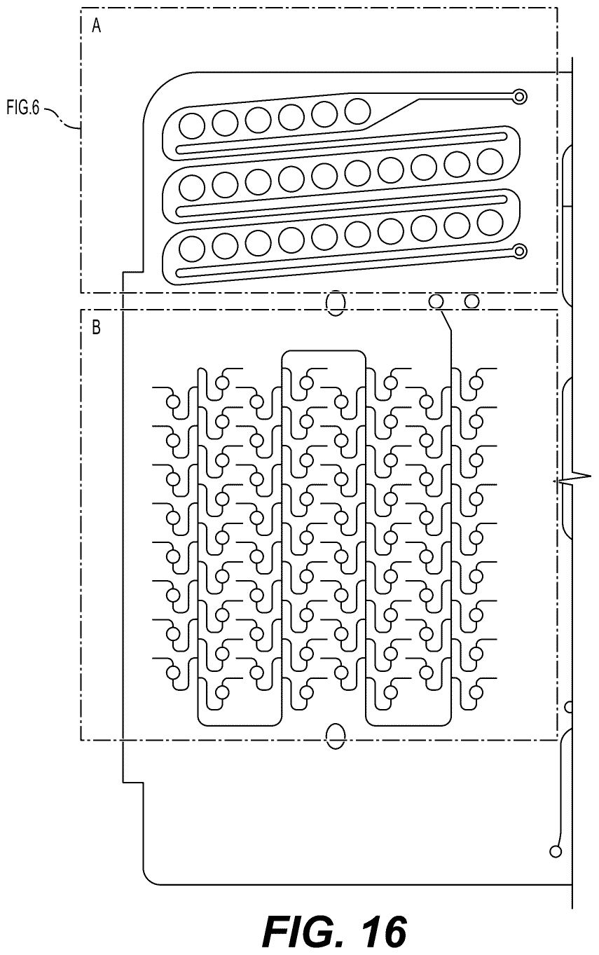

FIG. 16 depicts an example section of a cartridge implementing aspects of the disclosure described above. The cartridge includes a section (A) where the dried Mastermix reagents are stored and then resuspended according to the present disclosure, as well as a section (B) where an amplification array containing primers is used for measurement of amplification of multiple genes, as described above in reference to FIG. 15.

### Method for On-Cartridge Mastermix Reagent Rehydration

In another aspect of the disclosure, a method of resuspension and subsequent mixing of the Mastermix solution is described. As discussed above, the Mastermix chamber may be part of a more complex cartridge design with multiple technical features that are not described in detail here. Briefly, the design of the overall cartridge may include a mix chamber configured to homogenize the Mastermix reagents. Rehydration of the Mastermix reagents in the mix chamber may be based on the movement of fluids through the chamber (e.g., along a serpentine structure, as described above) by applying positive or negative pressure via gas ports. Fluid path control may be achieved by opening and closing active or passive valves.

For Mastermix rehydration, certain dimensional characteristics may be considered. Because all droplets should be resuspended robustly, and because air bubbles may be detrimental, laminar flow is desired. Low flowrates may be used in conjunction with the channel geometry described above to minimize the Reynolds number. Because Reynolds number is also strongly affected by the channel geometry, the flowrate may be tuned based on a combination of parameters, such as well depth, spacing, and diameter. This interaction means that particularly aggressive chamber designs may require relatively slow flowrates that may be infeasible mechanically or may be excessively slow. For a chamber with dimensions as described above, consistent laminar flow may be achieved in a range of 1-100 mm/s fluid velocity. In practical terms, it was observed that the filling of the Mastermix chamber with fluid should ideally happen in a single movement, with the fluid moving from the entrance, at the bottom of the chamber, to the venting channel at the top, with the front of the liquid moving perpendicular to the chamber walls.

To achieve successful reagent rehydration and homogenization of the Mastermix, the protocol was modified with the goal of obtaining effective reagent rehydration and homogenization while inhibiting bubble formation and reducing overall test duration. The integrity of the venting channels, or gas ports, was also protected to promote reproducible functionality of the system, so liquid movement timings take this into account. Specifically, the following parameters were identified.

During testing, for a Mastermix chamber with 26 containment wells, as shown in FIG. 3 above, a filling speed of about 15 mm/s with a pressure differential of 10 kPa achieved robust filling and reagent rehydration, while a filling speed of 100 mm/s resulted in significant bubble generation and increased incidence of spots being skipped, leading to incomplete rehydration of the dried Mastermix. Based on these findings, a low pressure was used for all the test iterations.

Another factor considered was dwell time for rehydration. Time may be given for the dried reagent droplets to fully rehydrate, since the movement of the liquid in a single step may not be sufficient for this purpose. To do this, the liquid may remain static for some time after covering the reagent droplets. A range of times was tested for this purpose. The dwell time may be in the range of approximately 30 seconds to approximately 180 seconds; for example, the dwell time may be approximately 30 seconds, approximately 50 seconds, approximately 60 seconds, approximately 90 seconds, or approximately 180 seconds, or any intervals or ranges in between.

In a subsequent step, pressure is added to the Mastermix reagent rehydration chamber while the reagent and rehydration chamber is closed, before opening the active valve to move the solution to the mixing chamber. In some embodiments, the Mastermix reagent rehydration chamber may be pressurized to a pressure in the range of approximately 20 kPa to approximately 40 kPa during filling. This favors the shuttle movement of the liquid once the valve is open, with reduced bubble formation.

Once the Mastermix reagent and rehydration chamber was pressurized to approximately 10 kPa for approximately 20 seconds or approximately 5 kPa for approximately 40 seconds, the valve was opened, and the liquid with the reconstituted Mastermix reagents were pushed out of Mastermix chamber and into Mixing chamber. The rehydrated Mastermix solution was then moved to the mixing chamber with a progressively reduced pressure or with low pressure. Settings may be selected to promote complete and controlled transfer of the liquid. Once the valve is opened, the pressure of the Mastermix reagent and rehydration chamber may be in the range of approximately 20 kPa, approximately 40 kPa, or approximately 60 kPa. The pressure may be reduced to approximately 5 kPa gradually after reaching a peak pressure. In some embodiments, a pressure of approximately 7 kPa was maintained for approximately 60 seconds; alternatively, the pressure may be maintained in a range of approximately 7 kPa to approximately 10 kPa for 30 seconds.

Once the liquid was in the mixing chamber, which may be a relatively deeper chamber compared to the Mastermix reagent chamber to allow for turbulent flow, different combinations of gas ports were opened and closed to evaluate the impact on reagent homogenization, specifically by the controlled introduction of bubbles to increase turbulence, and compared to no agitation at all. In some embodiments, no agitation may be used; alternatively, one or more cycles of agitation may be used, e.g., approximately 3 to 4 cycles of agitation may be used.

Pressurization of the closed mixing chamber was also assessed as a method to reduce bubbles created in the previous step and compared to no pressurization. In some embodiments, the closed mixing chamber may be pressurized to approximately 45 kPa. In some embodiments, the closed mixing chamber may not be pressurized.

Table 4 shows examples of parameter values that were used for different versions of the protocol script.

TABLE 4
Examples of different Mastermix rehydration
and homogenization protocol settings tested

| Key protocol steps | Examples of conditions tested |
|---|---|
| Pressure and time to fill the | 10 kPa for 20 s |
| Mastermix reagent and rehydration | 5 kPa for 40 s |
| chamber | |
| Dwell time for reagent rehydration | No fluid movement for 30/50/60/ |
| | 90/180 s |
| Pressurization of the Mastermix | 40 kPa then reduce to 20 kPa |
| reagent and rehydration chamber | No pressure build-up |
| Open valve, push liquid out of | 60/40/20 kPa with gradual decrease |
| Mastermix chamber and into mixing | to 5 kPa |
| chamber | 7 kPa for 60 s |
| | 7 to 10 kPa over 30 s |
| Agitation in mixing chamber | No agitation |
| | 3/4 cycles of push/pull using gas |
| | ports |
| Pressurize to reduce bubbles in | No pressurization |
| mixing chamber | 45 kPa to pressurize closed |
| | chamber |

Determining the proper rehydration and homogenization method took significant testing of a variety of conditions, as demonstrated above.

After the rehydration steps, described above, the liquid may be transferred to the amplification array region of the device, where it may be dispensed into an array for the nucleic acid amplification reaction to take place. In one example, the amplification array may include a plurality of individually vented 2-microliter wells. Although an amplification array is discussed as an example, any suitable array for any suitable assay may be used in conjunction with the Mastermix chamber and/or dried Mastermix reagents described herein. Given that arrays used in conjunction with embodiments of the disclosure may have tens of wells (in some embodiments, 68 individual wells, for example), achieving a homogenous Mastermix solution may promote good analytical performance of the amplification step, or any other suitable reaction step.

Table 5, shown below, depicts data on the stability of one example configuration of Mastermix reagents when tested with contrived samples after accelerated aging months (M) and/or days (D) at different temperatures. The data demonstrates stable long-term stability, as desired. Table 5 lists the bacterial (B) and viral (V) prevalence, as well as the severity(S) of the average, the delta to the control values, and the standard deviation of the bacterial, viral, and severity values, as well as a pass/fail indicator of the results.

TABLE 5
Example of results from cartridge runs demonstrating reagent functionality and stability

| | | | | | | | Delta to | | | Standard | | | |
|---|---|---|---|---|---|---|---|---|---|---|---|---|---|
| Time Point | | Temp. | Panel | Average | | | Control | | | Deviation (<5.5) | | | |
| M | D | (° C.) | Member | B | V | S | B | V | S | B | V | S | Results |
| 0 | 0 | RT | B | 47.00 | 7.83 | 48.00 | N/A | N/A | N/A | 0.00 | 0.98 | 0.89 | PASS |
| | | | C | 1.00 | 49.67 | 7.33 | N/A | N/A | N/A | 0.00 | 0.52 | 1.51 | PASS |
| 1 | 35 | 30 | B | 46.00 | 10.17 | 47.83 | −1.00 | 2.33 | −0.17 | 1.10 | 3.54 | 0.4 | PASS |
| | | | C | 0.50 | 49.67 | 5.83 | −0.50 | 0.00 | −1.20 | 0.55 | 0.52 | 1.14 | PASS |
| 3 | 100 | 15 | B | 46.33 | 9.17 | 48.67 | −0.67 | 1.30 | 0.67 | 0.82 | 3.37 | 0.52 | PASS |
| | | | C | 0.83 | 49.50 | 6.17 | −0.17 | −0.17 | −1.17 | 0.41 | 0.55 | 1.17 | PASS |
| 3 | 100 | 30 | B | 46.00 | 10.83 | 48.17 | −1.00 | 3.00 | 0.17 | 0.89 | 3.19 | 0.75 | PASS |
| | | | C | 1.00 | 49.17 | 5.00 | 0.00 | −0.50 | −2.33 | 0.00 | 0.41 | 0.63 | PASS |
| 3 | 62 | 37 | B | 45.83 | 9.33 | 47.17 | −1.17 | 1.50 | −0.83 | 1.17 | 2.94 | 0.98 | PASS |
| | | | C | 1.00 | 49.17 | 4.50 | 0.00 | −0.50 | −2.83 | 0.00 | 0.41 | 1.05 | PASS |
| 6 | 192 | 15 | B | 46.00 | 9.50 | 48.50 | −1.00 | 1.67 | 0.50 | 1.10 | 2.35 | 0.55 | PASS |
| | | | C | 1.00 | 49.50 | 6.50 | 0.00 | −0.17 | −0.83 | 0.00 | 0.55 | 1.05 | PASS |
| 6 | 192 | 30 | B | 45.50 | 10.67 | 47.17 | −1.50 | 2.83 | −0.83 | 1.87 | 3.88 | 2.14 | FAIL |
| | | | C | 1.00 | 49.17 | 4.67 | 0.00 | −0.50 | −2.67 | 0.00 | 0.41 | 1.51 | PASS |
| 6 | 119 | 37 | B | 47.17 | 7.17 | 48.67 | 0.17 | −0.67 | 0.67 | 1.17 | 2.64 | 0.52 | PASS |
| | | | C | 1.00 | 49.00 | 6.83 | 0.00 | −0.67 | −0.50 | 0.00 | 0.00 | 1.33 | PASS |
| 9 | 283 | 15 | B | 46.17 | 9.50 | 48.50 | −0.83 | 1.67 | 0.50 | 1.17 | 3.78 | 0.55 | PASS |
| | | | C | 0.83 | 49.17 | 6.67 | −0.17 | −0.50 | −0.67 | 0.41 | 0.41 | 1.03 | PASS |
| 9 | 283 | 30 | B | 46.83 | 7.00 | 48.17 | −0.17 | −0.83 | 0.17 | −0.17 | −0.83 | 0.17 | PASS |
| | | | C | 1.33 | 48.67 | 6.17 | 0.33 | −1.00 | −1.17 | 0.33 | −1.00 | −1.17 | PASS |
| 9 | 175 | 37 | B | 47.00 | 7.17 | 48.17 | 0.00 | −0.67 | 0.17 | 0.63 | 2.23 | 0.75 | PASS |
| | | | C | 1.00 | 49.00 | 7.83 | 0.00 | −0.67 | 0.50 | 0.00 | 0.00 | 1.17 | PASS |
| 12 | 231 | 37 | B | 47.33 | 6.17 | 48.40 | 0.33 | −1.67 | 0.40 | 0.52 | 1.83 | 0.55 | PASS |
| | | | C | 1.50 | 49.17 | 8.83 | 0.50 | −0.50 | 1.50 | 0.55 | 0.41 | 2.32 | PASS |

Embodiments of the disclosure may facilitate the deployment of point-of-care devices performing nucleic acid amplification, or other assays, which may be relevant across a wide range of clinical applications in human and veterinary health.

When integrated into a fluidic structure for processing samples, embodiments of the disclosure may provide robust Mastermix functionality with a long shelf-life.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A cartridge comprising:
a substrate having a plurality of wells arranged along a flow path;
a first subgroup of dried Mastermix reagents contained within a first well of the plurality of wells;
a second subgroup of dried Mastermix reagents contained within a second well of the plurality of wells; and
a third subgroup of dried Mastermix reagents contained within a third well of the plurality of wells,
wherein, collectively, the Mastermix reagents in the first subgroup, the second subgroup, and the third subgroup comprise all reagents needed for performing nucleic acid amplification.

2. The cartridge of claim 1, wherein the third subgroup contains reagents having a salt concentration that is higher than a salt concentration of at least one of the first subgroup or the second subgroup.

3. The cartridge of claim 1, wherein the third subgroup contains reagents having a salt concentration that is higher than a salt concentration of the first subgroup, and wherein the first or the second subgroup contains at least one enzyme that denatures when exposed to the salt concentration of the third subgroup.

4. The cartridge of claim 1, wherein the third subgroup contains reagents having a salt concentration that is higher than a salt concentration of the first subgroup, wherein the first subgroup contains at least one enzyme that denatures when exposed to the salt concentration of the third subgroup, and wherein the second well is spaced between the first well and the third well along the flow path.

5. The cartridge of claim 1, wherein the plurality of wells each have a width of approximately 2.5 mm to approximately 4.5 mm and a depth of approximately 50 μm to approximately 450 μm.

6. The cartridge of claim 1, wherein the plurality of wells includes a plurality of first wells, a plurality of second wells, and a plurality of third wells.

7. The cartridge of claim 1, wherein the first well is not directly next to the third well, and the first well is positioned upstream relative to the third well along the flow path.

8. The cartridge of claim 1, wherein the first subgroup comprises nucleic acid polymerase and reverse transcriptase.

9. The cartridge of claim 1, wherein the second subgroup comprises at least one of fluorescence dye and deoxyribonucleotide triphosphates.

10. The cartridge of claim 1, wherein the third subgroup comprises magnesium sulfate, a buffer, and a salt.

11. A method of forming a cartridge to be used for nucleic acid amplification, the method comprising:
dispensing a first droplet of a first solution into a first well arranged along a flow path of the cartridge, wherein the first solution contains a first subgroup of Mastermix reagents, and wherein the first droplet makes contact with walls of the first well when the first droplet is received within the first well;
dispensing a second droplet of a second solution into a second well arranged along the flow path of the cartridge, wherein the second solution contains a second subgroup of Mastermix reagents, and wherein the second droplet makes contact with walls of the second well when the second droplet is received within the second well;
dispensing a third droplet of a third solution into a third well arranged along the flow path of the cartridge, wherein the third solution contains a third subgroup of Mastermix reagents, and wherein the third droplet makes contact with walls of the third well when the third droplet is received within the third well; and
drying the first droplet, the second droplet, and the third droplet,
wherein, collectively, the Mastermix reagents in the first subgroup, the second subgroup, and the third subgroup comprise all reagents needed for performing nucleic acid amplification.

12. The method of claim 11, wherein the drying comprises at least one of (i) exposing the first droplet, the second droplet, and the third droplet to a low-humidity air flow, or (ii) vacuum drying the first droplet, the second droplet, and the third droplet.

13. The method of claim 11, wherein a volume of the first droplet of the first solution dispensed into the first well is approximately 1.50 μL to approximately 7.50 μL, wherein a volume of the second droplet of the second solution dispensed into the second well is approximately 1.50 μL to approximately 9.30 μL, and wherein a volume of the third droplet of the third solution dispensed into the third well is approximately 1.50 μL to approximately 6.00 μL.

14. The method of claim 11, wherein a plurality of first droplets are each dispensed into one of a plurality of first wells, a plurality of second droplets are each dispensed into one of a plurality of second wells, and a plurality of third droplets are each dispensed into one of a plurality of third wells.

15. The method of claim 11, wherein the third subgroup contains reagents having a salt concentration that is higher than a salt concentration of the first subgroup, and wherein the first subgroup contains at least one enzyme that denatures when exposed to the salt concentration of the third subgroup.

16. The method of claim 11, wherein the third subgroup contains reagents having a salt concentration that is higher than a salt concentration of the first subgroup, wherein the first subgroup contains at least one enzyme that denatures when exposed to the salt concentration of the third subgroup, and wherein the third droplet is not dispensed into a well of the plurality of wells that is directly next to a well of the plurality of wells into which a first droplet is dispensed.

17. The method of claim 11, wherein the first subgroup comprises nucleic acid polymerase and reverse transcriptase.

18. The method of claim 11, wherein the second subgroup comprises at least one of fluorescence dye and deoxyribonucleotide triphosphates.

19. The method of claim 11, wherein the third subgroup comprises magnesium sulfate, a buffer, and a salt.

20. A method of rehydrating a plurality of subgroups of dried Mastermix reagents, the method comprising:
introducing a fluid into a flow path of a cartridge, wherein a plurality of wells are arranged along the flow path, wherein a first well along the flow path contains a first dried subgroup of Mastermix reagents, a second well along the flow path contains a second dried subgroup of Mastermix reagents, and a third well along the flow path contains a third dried subgroup of Mastermix reagents, and wherein, collectively, the Mastermix reagents in the first subgroup, the second subgroup, and the third subgroup comprise all reagents needed for performing nucleic acid amplification,
wherein a salt concentration of the third subgroup is higher than a salt concentration of the first subgroup and the second subgroup, and wherein the fluid is introduced first into at least one of the first well or the second well to rehydrate at least the dried first subgroup or the dried second subgroup, respectively, before being introduced into the third well to rehydrate the third subgroup.
